(19) United States
(12) Patent Application Publication
(10) Pub. No.: US 2026/0043897 A1
(43) Pub. Date: Feb. 12, 2026

(54) TARGET DETECTION METHOD, DEVICE CONTROL METHOD, AND COMPUTER DEVICE

(71) Applicant: LUMI UNITED TECHNOLOGY CO., LTD., Shenzhen City (CN)

(72) Inventors: ZHAOZE ZENG, Shenzhen City (CN); BINBIN HUANG, Shenzhen City (CN); QIN YAO, Shenzhen City (CN)

(73) Assignee: LUMI UNITED TECHNOLOGY CO., LTD., Shenzhen City (CN)

(21) Appl. No.: 19/363,489

(22) Filed: Oct. 20, 2025

Related U.S. Application Data
(63) Continuation-in-part of application No. PCT/CN2024/088450, filed on Apr. 17, 2024.
(63) Continuation-in-part of application No. PCT/CN2024/084617, filed on Mar. 28, 2024.

(30) Foreign Application Priority Data
Apr. 18, 2023 (CN) 202310438320.4
Apr. 21, 2023 (CN) 202310462214.X

(51) Int. Cl. G01S 7/10; G01S 13/58; G01S 13/89; G05B 13/02; G06T 7/246; G06T 7/73; G06V 10/764; G06V 10/774

(52) U.S. Cl. CPC G01S 7/10; G01S 13/58; G01S 13/89; G05B 13/0265; G06T 7/248; G06T 7/74; G06V 10/764; G06V 10/774; G06T 2207/10028; G06T 2207/20081; G06T 2207/20104; G06T 2207/30196; G06T 2207/30204; G06T 2207/30241

(57) ABSTRACT

The present disclosure relates to a target detection method, a device control method, and a computer device. Specifically, the target detection method includes: displaying a target detection page; acquiring position information of a target object in a target space, wherein the position information is determined by motion trajectory data of the target object in the target space; and, in the target detection page, displaying in real time a position marker corresponding to the target object, wherein a page position of the position marker is determined based on the position information of the target object in the target space.

This disclosure is a continuation in part of International Patent Application No. PCT/CN2024/084617 filed on Mar. 28, 2024, and International Patent Application No. PCT/CN2024/088450 filed on Apr. 17, 2024, each of which claims priority to Chinese Patent Application Nos. 202310462214. X filed on Apr. 21, 2023, and 202310438320.4 filed on Apr. 18, 2023, respectively.

### TECHNICAL FIELD

The present disclosure relates to the field of computer technologies, and in particular to a target detection method, a device control method, and a computer device.

### BACKGROUND

With the continuous development of Internet of Things (IoT) technologies, products related to IoT technologies keep advancing. Smart home services have gradually entered people's daily life. Implementation of smart home services mainly relies on the position of a target object in a home space; therefore, position information of the target object in the home space needs to be acquired accurately. However, related technologies may not acquire the position information of the target object accurately, so that smart home services may not be carried out effectively, and user experience is reduced.

### SUMMARY OF THE DISCLOSURE

The present disclosure provides a target detection method, performed by a computer device, the method including: displaying a target detection page; acquiring position information of a target object in a target space, wherein the position information is determined by motion trajectory data of the target object in the target space; and in the target detection page, displaying in real time a position marker corresponding to the target object, wherein a page position of the position marker is determined based on the position information of the target object in the target space.

Embodiments of the present application further propose a device control method, including: acquiring a point cloud data frame in a target space collected in real time by a detection device, wherein the point cloud data frame includes at least one point cloud; according to a distance relationship, querying, from historical motion trajectories, a target motion trajectory associable with the point cloud, wherein the target motion trajectory is jointly constructed from the point cloud in one or more frames of historical point cloud data; calculating a target trajectory point of the target motion trajectory based on the point cloud associable with the target motion trajectory; extending the target motion trajectory to the corresponding target trajectory point, to obtain motion trajectory data; and determining position information of the target object in the target space, based on the motion trajectory data.

The present disclosure also provides a computer device including a processor, a memory, and a computer program stored in the memory and executable by the processor, wherein when the computer program is executed by the processor, the processor implements the target detection method described above.

The present disclosure also provides a computer readable storage medium storing computer readable instruction which, when executed by a processor, implement the target detection method described above.

The present disclosure also provides a computer program product including computer readable instructions which, when executed by a processor, implement the target detection method described above.

### BRIEF DESCRIPTION OF THE DRAWINGS

To illustrate the technical solutions provided in the present disclosure more clearly, drawings to be used in embodiments of the present disclosure are introduced briefly below. Obviously, the drawings described below are merely some embodiments of the present disclosure, and a person of ordinary skill in the art may obtain other drawings from these drawings without creative efforts.

FIG. 1 is a schematic diagram of an application scenario of a target detection system provided by an embodiment of the present disclosure.

FIG. 2 is a schematic diagram of an implementation environment provided by an embodiment of the present disclosure.

FIG. 3 is a flow chart diagram of steps of a target detection method provided by an embodiment of the present disclosure.

FIG. 4 is a schematic diagram of an information display page and a monitoring page provided by an embodiment of the present disclosure.

FIG. 5 is a flow chart diagram of further steps of the target detection method provided by an embodiment of the present disclosure.

FIG. 6 is a flow schematic diagram of associating point clouds with motion trajectories provided by an embodiment of the present disclosure.

FIG. 7 is a flow schematic diagram of a radar device acquiring position information of a target object and transmitting the position information to a terminal provided by an embodiment of the present disclosure.

FIG. 8 is a flow schematic diagram of a device control method in an embodiment.

FIG. 9 is a schematic diagram of a Doppler time spectrogram in an embodiment.

FIG. 10 is a schematic diagram of division of region types of a monitoring region in an embodiment.

FIG. 11 is a flow schematic diagram of a target detection method in an embodiment.

FIG. 12 is a schematic diagram of a monitoring page in an embodiment.

FIG. 13 is a first structural schematic diagram of a target detection apparatus provided by an embodiment of the present disclosure.

FIG. 14 is a second structural schematic diagram of the target detection apparatus provided by an embodiment of the present disclosure.

FIG. 15 is a structural schematic diagram of a computer device provided by an embodiment of the present disclosure.

### DETAILED DESCRIPTION

To make the objectives, technical solutions and advantages of the present disclosure clearer, the present disclosure is further described in detail below with reference to the accompanying drawings and embodiments. It should be understood that the specific embodiments described herein are merely for illustrating the present disclosure and are not intended to limit the present disclosure.

Embodiments of the present disclosure provide a target detection method, apparatus and computer readable storage medium. Specifically, the embodiments of the present disclosure are described from the perspective of a target detection apparatus, which may be integrated in a computer device. The computer device may be a server or a terminal device. The server may be an independent physical server, a server cluster or distributed system formed by a plurality of physical servers, or a cloud server providing basic cloud computing services such as cloud services, cloud databases, cloud computing, cloud functions, cloud storage, network services, cloud communication, middleware services, domain name services, security services, CDN, big data and artificial intelligence platforms. The terminal may be a smart phone, a smart control panel, a tablet computer, a notebook computer, a desktop computer, a smart speaker, a smart watch, a smart appliance, a vehicle mounted terminal, an intelligent voice interaction device, an aircraft, etc., but is not limited thereto.

The target detection method provided by embodiments of the present disclosure may be applied to various application scenarios, such as but not limited to a smart home space, and is illustrated below by way of specific embodiments.

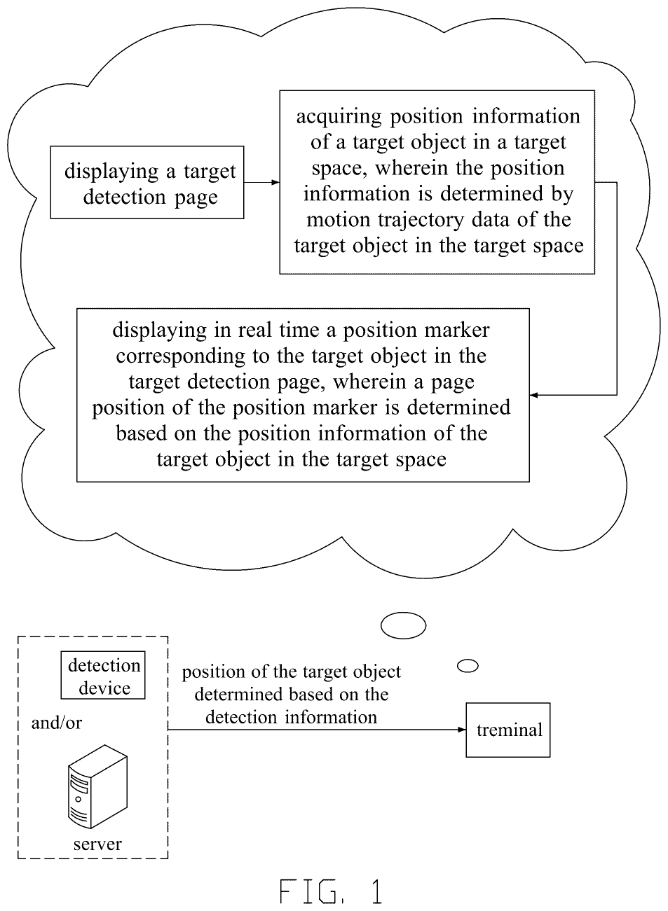

For example, referring to FIG. 1, a schematic diagram of a target detection system provided by an embodiment of the present disclosure is shown. The system may include a terminal and a data processing end, and a specific implementation scenario may be as follows:

The terminal may be configured to: display a target detection page; acquire position information of a target object in a target space, wherein the position information is determined by motion trajectory data of the target object in the target space; and in the target detection page, display in real time a position marker corresponding to the target object, wherein a page position of the position marker is determined based on the position information of the target object in the target space.

The data processing end may be a detection device or a server, or a combination of a detection device and a server. The detection device may be a device capable of detecting the position of a face, for example, a body sensor, a millimeter wave radar, etc.

Specifically, the data processing end may be configured to: acquire a point cloud data frame in a target space collected in real time by a detection device, the point cloud data frame including at least one point cloud; according to a distance relationship, query, from historical motion trajectories, a target motion trajectory associable with the point cloud, wherein the target motion trajectory is jointly constructed from a point cloud in one or more frames of historical point cloud data; calculate a target trajectory point of the target motion trajectory based on a point cloud associable with the target motion trajectory; extend the target motion trajectory to a corresponding target trajectory point to obtain motion trajectory data; and determine position information of the target object in the target space based on the motion trajectory data.

The target detection process may include displaying the target detection page, prompting the target object to move, collecting detection information of the moving process of the target object, determining the position of the target object, displaying the position of the target object in the target detection page, etc.

At present, automation control of devices is relatively single, and usually only controls turning on or off a device by recognizing whether there is a person or an object with temperature. Moreover, such control is limited to some devices. In addition, judging whether to turn on or off a device only by whether there is a person or an object with temperature results in a single control mode and fails to achieve flexible control of the device, leading to low user experience. In view of this, embodiments of the present application provide a device control method: target features of each target object under each monitoring region are acquired; action states of the target object are obtained according to the target features; an automation control scheme corresponding to the action state of the target object is determined according to the action state; and a target device corresponding to the monitoring region in which the target object is located is instructed to execute the automation control scheme. The technical solution of the embodiments of the present application implements control of a target device corresponding to a monitoring region according to the action state of the target object in the monitoring region, improving control flexibility and accuracy.

To make the purpose, technical solution and advantages of the present application clearer, the implementation modes of the present application are described in detail below with reference to the accompanying drawings.

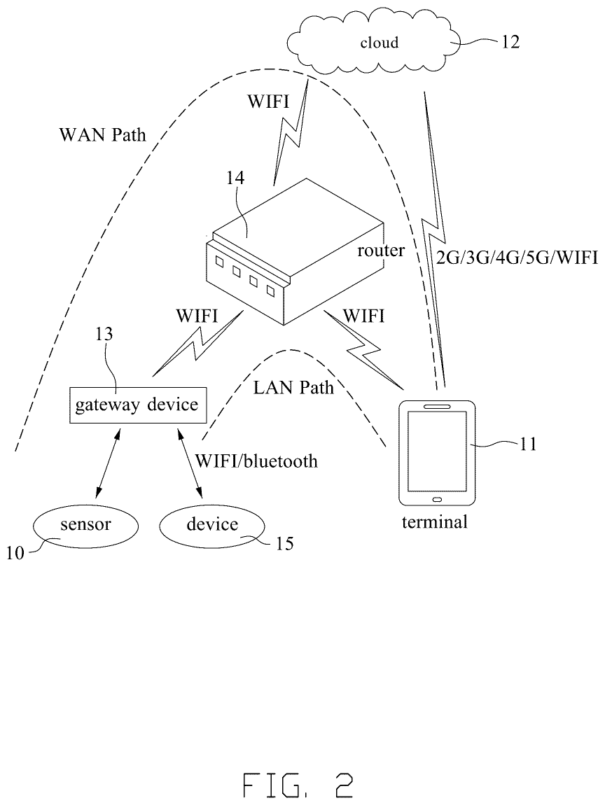

FIG. 2 is a schematic diagram of an implementation environment related to a device control method in an embodiment. In an implementation mode, the implementation environment is applicable to a smart home scenario, and includes a sensor 10, a terminal 11, a cloud 12, a gateway device 13, a router 14 and a device 15.

Specifically, the terminal 11 may be any smart device with communication and storage functions, such as but not limited to a smart phone, a tablet computer, a notebook computer, a desktop computer and other computer devices with network connection functions. The cloud 12 may be a network access server, a database server, a cloud server, etc. In an embodiment, the gateway device 13 may be built based on a ZigBee protocol, the device 15 may be controlled by the sensor 10, the terminal 11 or the cloud 12, and may be pre joined to the gateway device 13. For example, the device 15 may be a device belonging to a kit of the gateway device 13 at the factory, or may be a device subsequently connected to the gateway device 13 by user operation.

In an embodiment, a client capable of managing the device 15 is installed in the terminal 11. The client may be an application client (e.g., an APP of a mobile phone) or a web client, which is not limited herein.

In an embodiment, the sensor 10 may establish a network connection with the gateway device 13 based on a ZigBee protocol, thereby joining a ZigBee network.

In an embodiment, the sensor 10, the terminal 11 and the device 15 may all access an Ethernet through the gateway device 13. The gateway device 13 may access the cloud 12 through a wired or wireless communication connection. For example, the gateway device 13 and the terminal 11 may store acquired information in the cloud 12. In an embodiment, the terminal 11 may also establish a network connection with the cloud 12 through 2G/3G/4G/5G, WiFi, etc., so as to acquire data issued by the cloud 12.

In an embodiment, the terminal 11, the gateway device 13 and the sensor 10 may be in a same local area network (LAN), or may be in a same wide area network (WAN) with the cloud 12. When the terminal 11 and the gateway device 13 are in the same LAN, the terminal 11 may interact with the gateway device 13 and the sensor 10 connected to the gateway device 13 through a LAN path, or may interact with the gateway device 13 and the sensor 10 connected to the gateway device 13 through a WAN path. When the terminal 11 and the gateway device 13 are not in the same LAN, the terminal 11 may interact with the gateway device 13 and the sensor 10 connected to the gateway device 13 through a WAN path. The device 15 may include, but is not limited to, smart lamps, automatic curtains, air conditioners and other smart home products.

An automation control scheme refers to a linkage application scheme constructed between the gateway device 13 or the device 15 connected to the gateway device 13. The automation control scheme includes a trigger condition, a controlled target device and an execution action. Devices implementing automated scene control include a trigger device and a controlled target device (a controlled device). The two may communicate through the gateway device 13. When an action state of a target object acquired by the trigger device satisfies the trigger condition, the gateway device 13 controls the controlled device to execute a corresponding execution action. The trigger device may be various sensors such as radar sensors, pressure sensors, etc. For example, the controlled device may be various switches, televisions, sockets, lamps and other devices 15.

Assume that an IoT system sets an automation control scheme: in a certain monitoring region of a target space, when an action state of a target object is detected and the action state is static, a lamp corresponding to the monitoring region is turned off. Based on this application scenario, a radar sensor may be set as a trigger device, and a smart switch connected to the lamp may be set as a controlled device. A specific execution principle is: if automation is executed locally at the gateway through a LAN path, the radar sensor detects the action state of the target object located in the monitoring region, and reports the event to the gateway. After receiving the action state of the target object, the gateway determines that the action state is static according to stored automation configuration information, that is, the trigger condition is satisfied, finds the device 15 corresponding to the monitoring region (in this embodiment, the smart switch), and notifies the smart switch to execute a target action, i.e., turning off the lamp. Thereby, an automated linkage is implemented: when the action state of the target object detected in the monitoring region of the target space is static, the lamp corresponding to the monitoring region is automatically turned off. If automation is executed in the cloud through a WAN path, the radar sensor detects the action state of the target object, reports the event to the gateway, and after receiving the event that the action state of the target object is detected, the gateway reports the event to the cloud. The cloud finds the device 15 corresponding to the monitoring region (in this embodiment, the smart switch) according to stored scene configuration information, and notifies the smart switch to execute the lamp turning off action through the gateway.

The following detailed descriptions are respectively given. It should be noted that the order of the following embodiments is not taken as a limitation on the preferred order of the embodiments.

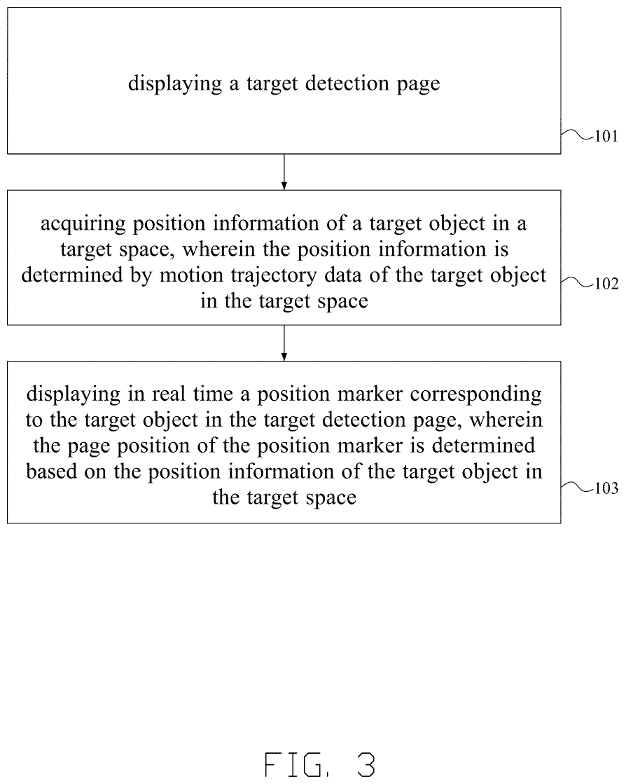

In the present disclosure embodiment, description is given from the angle of a target detection apparatus, which may be integrated in a computer device such as a terminal. Referring to FIG. 3, FIG. 3 is a flow chart diagram of steps of a target detection method provided by an embodiment of the present disclosure. When the processor of the terminal executes program instructions corresponding to the target detection method, the specific procedure is as follows, and the target detection method may be used in a device control method for target detection:
101. displaying a target detection page;

In the present disclosure embodiment, in order to accurately obtain position information of a target object in a target space, the monitoring range of the target space needs to be determined first. For example, in a smart home scenario, in order to record information for providing an automation control scheme for home appliances indoors, it is necessary to determine whether a user has reached the area where the home appliance is located. A radar detection device may first detect the position of the target object, and then report the position to a user side, so that the position of the target object is displayed in a target detection page of the user side, so as to subsequently record the time when the target object moves into the area within the range of the home automation control scheme, and at the same time realize automation control of home appliances in the smart home.

The above is only an example. The embodiments of the present disclosure may also be applied to target detection processes in spaces of other scenarios, such as home scenes, office places, indoor sports venues, indoor parking lots, etc. The listed examples are not limitations on implementing the solutions of the present disclosure.

It should be noted that a spatial area described in the present disclosure may be understood as an area configured in the target detection page for the target space.

The target detection page may be a content screen containing position information corresponding to the target object, and corresponds to the monitoring range of the target space, and is configured to display in real time positions of respective target objects in the target space. Illustratively, the target detection page may include a content display area, and the content display area may be configured to display the position of the target object.

Specifically, when a target application for detecting the target space is installed in the terminal, the target detection page may be entered through the target application, or the target detection page may be connected through a web page. At this time, a display interface of the terminal displays the target detection page, the target detection page corresponding to the monitoring range of the target space and being capable of displaying in real time positions of respective target objects in the target space, so that a user may view in real time positions of target objects in the target space from the terminal.

Through the above manner, the terminal may display the target detection page, so that the user may view positions of target objects in the target space through the target detection page.

102. acquiring position information of a target object in a target space, wherein the position information is determined by motion trajectory data of the target object in the target space;

The target object is an object capable of moving, including but not limited to a person or a living animal. The target space is a space with a boundary range, and may be, for example, an entire house or functional areas such as a living room or a dining room.

In the present disclosure embodiment, after the target detection page in the terminal is turned on, the terminal acquires position information of the target object sent by a detection device. It is noted that the position information of the target object is determined by a motion trajectory of the target object in the target space.

Specifically, after a user opens the target detection page in the terminal, the terminal acquires position information of the target object sent by the detection device through an information transmission channel established with the detection device. It is noted that each target object corresponds to one motion trajectory in the target space, and the position information of the target object is determined by the motion trajectory of the target object in the target space.

Illustratively, a target object AA moves from a point a to a point b in the target space, and a motion trajectory appears in the process from a to b, an end point of the motion trajectory being the current position of the target object AA, and the terminal acquires position information of the target object AA at b, including but not limited to coordinate values, speed values, etc. at b.

In some implementations, the position information is determined by motion trajectory data of the target object in the target space.

For example, step 102 may include:

The position information is determined by motion trajectory data of the target object in the target space, wherein the motion trajectory data is derived by using a point cloud of the target object in the target space to update historical motion trajectories associated with the point cloud.

Specifically, a detection device obtains point clouds in the target space based on radar measurement, laser measurement or photogrammetry principles, including three dimensional coordinates (XYZ), laser reflection intensity (Intensity) and color information (RGB). It is noted that a plurality of sampling points with spatial coordinates may be acquired on a surface of the target object, and a set of the sampling points is the point cloud of the target object. The detection device acquires point clouds in the target space at all times, and when the target object moves in the target space, changes of point clouds in each data frame corresponding to the target object construct a motion trajectory of the target object in the target space, and the detection device may determine position information of the target object in the target space through the motion trajectory of the target object.

Through the above manner, position information of the target object in the target space may be acquired, so that the position of the target object may be displayed in the target detection page.

103. displaying in real time a position marker corresponding to the target object in the target detection page, wherein the page position of the position marker is determined based on the position information of the target object in the target space;

In the present disclosure embodiment, in order to visualize the position of the target object, after acquiring the position information of the target object in the target space, the terminal displays in real time in the target detection page the position marker corresponding to the target object, so as to visually show the user the position of the target object in the target space.

Specifically, after acquiring the position information of the target object sent by the detection device, the terminal displays in real time in the target detection page the position marker corresponding to the target object. It is noted that the page position of the position marker corresponding to the target object is determined by the position information of the target object in the target space.

In some implementations, the target detection page contains a plurality of position markers, and each position marker corresponds to one target object.

For example, after step 103, the method may further include:
when position information of the target object in the target space is not acquired within a preset duration, deleting the position marker corresponding to the target object from the target detection page.

Specifically, the detection device detects position information of the target object in the target space at all times and sends the position information to the terminal. When the target object leaves the target space, the detection device may not detect the position information of the target object in the target space and no longer sends the position information of the target object to the terminal. When the terminal does not receive the position information of the target object within a preset waiting duration, the terminal determines by default that the target object has left the target space and deletes the position marker of the target object that originally existed in the target detection page.

In some implementations, the target detection page may be composed of an information display page and a monitoring page, wherein the monitoring page includes a pre-set monitoring region for responding to an automation control scheme.

For example, the above target detection method may further include:
(103.A) acquiring an information display instruction for the monitoring region, wherein the information display instruction is triggered when any position marker first appears in the monitoring region or when all position markers have left the monitoring region;
(103.B) based on the information display instruction, displaying in the information display page time information when any position marker is in the monitoring region, and/or displaying an execution status of the automation control scheme.

The information display page may be an interface in the terminal for displaying an execution status of an automation scheme in the monitoring region and time information of the target object in the monitoring region. If the target object triggers a corresponding automation control service in the monitoring region, the information display page records and displays a status of the automation control service and time information of the target object in the monitoring region.

The monitoring region may be a spatial area in the target space for setting an automation control scheme (the monitoring region may be a partial area of the target space or the entire target space), and the monitoring region may be configured to set an intelligent service of smart home, and the monitoring page in the target detection page may visualize the monitoring region.

Specifically, the target detection page is composed of the information display page and the monitoring page, the monitoring page is configured to display the position marker of the target object, and the information display page is configured to display information in the monitoring page. It is noted that a plurality of monitoring regions for setting automation control schemes may exist in the target space. When any one or more target objects move into a monitoring region in the target space, an automation control scheme in the monitoring region is triggered, and at the same time an information display instruction of the monitoring region is triggered, or when all target objects leave the monitoring region, the information display instruction of the monitoring region is also triggered. When the terminal detects the information display instruction, the terminal displays in the information display page time information when a position marker of any target object is in the monitoring region, and/or an execution status of the automation control scheme in the monitoring region.

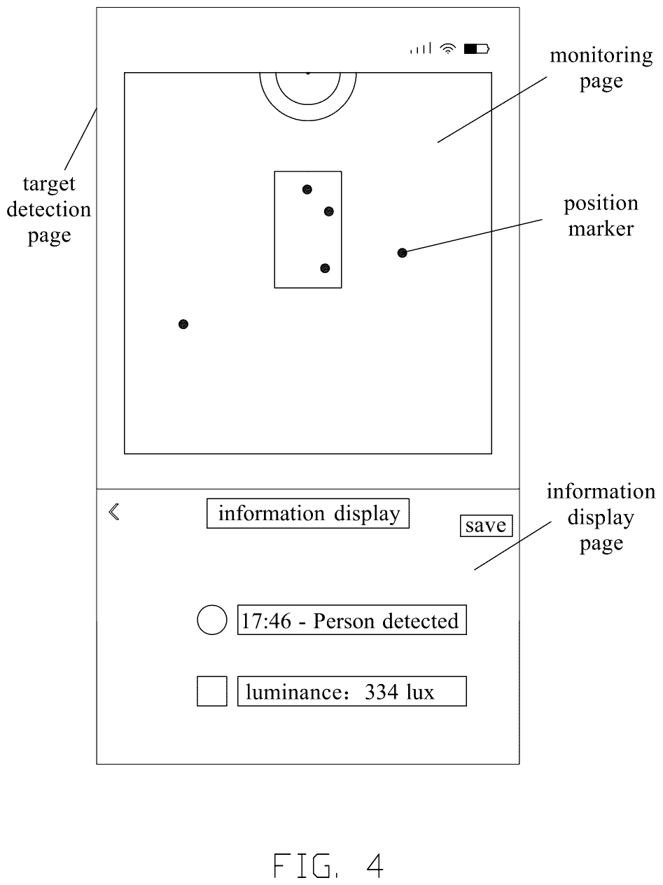

Illustratively, as shown in FIG. 4, the monitoring page in the target detection page has five position markers and one monitoring region A. Before 17:46, no person is in the monitoring region A, and no position marker exists in the monitoring page. At 17:46, any position marker enters the monitoring region A, and the information display page displays that a person is in the monitoring region A at 17:46 and displays a triggered lighting service status of the monitoring region A, i.e., an execution status of the automation control scheme.

Through the above manner, the terminal may, according to the position information of the target object in the target space, display in real time in the target detection page the position marker corresponding to the target object, so as to visually show the user the position of the target object in the target space.

By implementing any one or any combination of the above embodiments, the application scenario of the target detection process may be realized.

It may be seen that the embodiments of the present disclosure may: display a target detection page; acquire position information of a target object in a target space, wherein the position information is determined by motion trajectory data of the target object in the target space; and display in real time in the target detection page a position marker corresponding to the target object, wherein the page position of the position marker is determined based on the position information of the target object in the target space. Therefore, after the target detection page is displayed on the terminal, the position information of the target object in the target space is accurately determined according to the motion trajectory data of the target object, so as to avoid confusion of position information caused by too close distances among a plurality of target objects in the target space, and the position marker of the target object is displayed in real time in the target detection page according to the position information, so as to provide visual service for a user. In this way, the motion trajectory of the target object is updated according to point cloud data in the target space, so that the position information of each object is accurately acquired according to the motion trajectory, and the user experience is improved.

The method described in the above embodiments is further detailed below by way of example.

The embodiments of the present disclosure take data processing as an example to further describe the data processing method provided by the embodiments of the present disclosure.

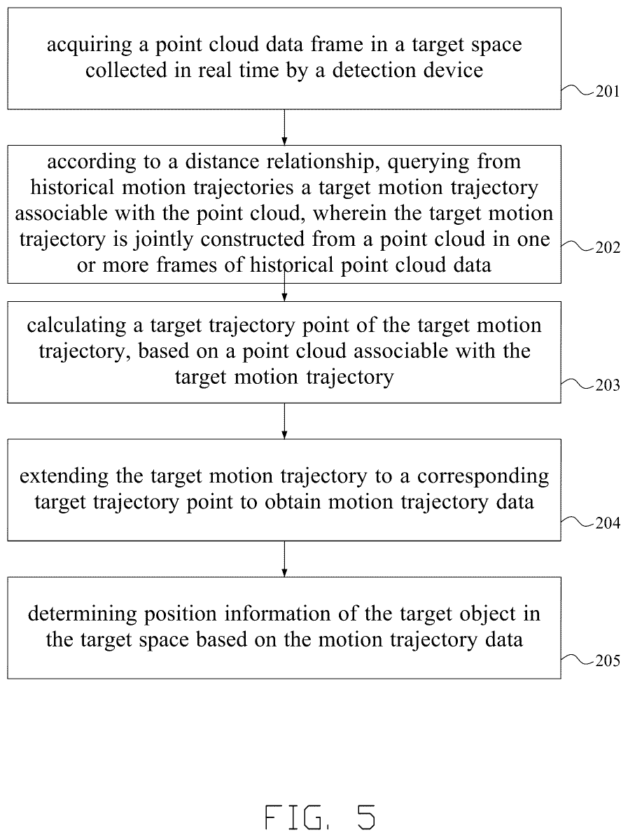

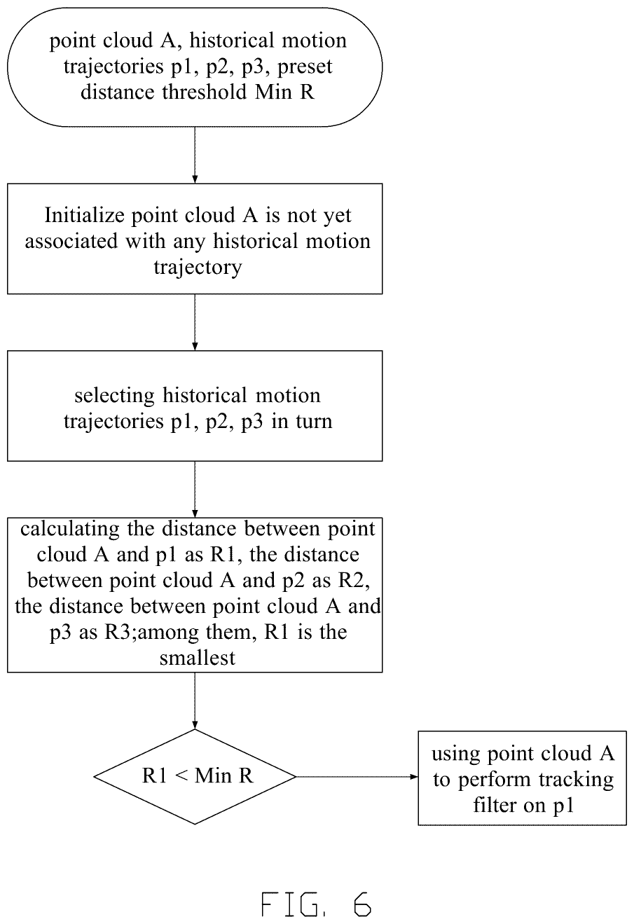

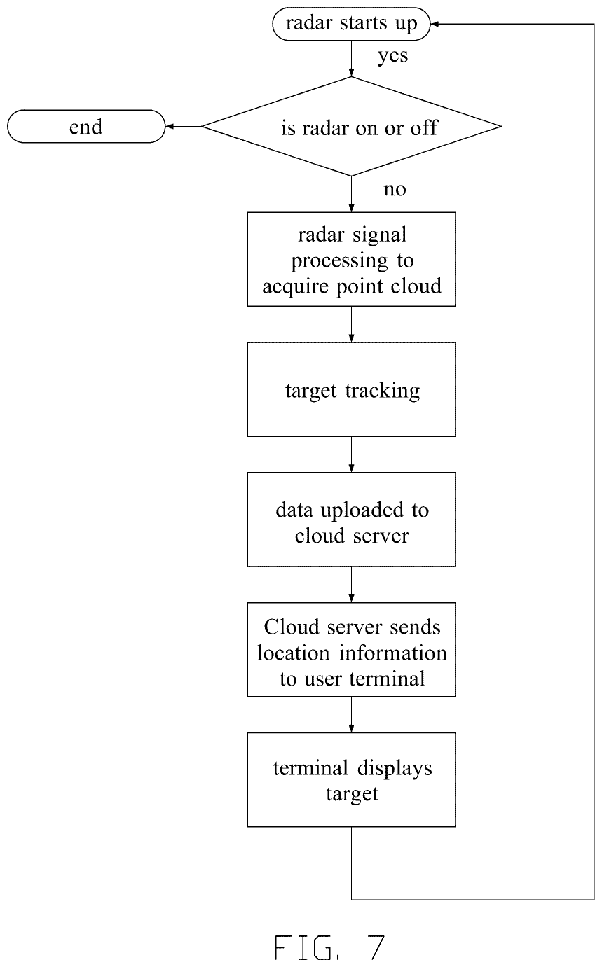

FIG. 5 is a flow chart diagram of further steps of the target detection method provided by an embodiment of the present disclosure, FIG. 6 is a flow schematic diagram of associating point clouds with motion trajectories provided by an embodiment of the present disclosure, and FIG. 7 is a flow schematic diagram of a radar device acquiring position information of a target object and transmitting the position information to a terminal provided by an embodiment of the present disclosure. For ease of understanding, the embodiments of the present disclosure are described with reference to FIGS. 5-7.

In the embodiments of the present disclosure, description is given from the angle of a target detection apparatus, which may be integrated in a computer device such as a detection device, a terminal or a server. For example, when a processor of the computer device executes a program corresponding to the target detection method, the specific procedure of the target detection method is as follows, and the target detection method may be used in a device control method for target detection:

201. acquiring a point cloud data frame in a target space collected in real time by a detection device;

In the present disclosure embodiment, in order to track in real time a motion trajectory of a target object in a target space, so as to obtain position information of the target object in the target space and implement an intelligent automatic control scenario for related devices or functional components, point cloud data frames in the target space may first be collected in real time by a detection device, so that a motion trajectory of the target object is subsequently determined according to point clouds in the point cloud data frames, and position detection of the target object is made more accurate.

The point cloud data frame may be a point cloud data map acquired by the detection device in the target space at every time frame, and the point cloud data frame contains at least one point cloud.

Specifically, a LiDAR device or other wireless signal detection device may scan the target space, acquire sampling points on surfaces of all objects in the target space, and cluster sampling points that are relatively close into corresponding point cloud data, i.e., the point cloud data frames corresponding to the target space collected in real time.

Through the above manner, point cloud data frames in the target space may be collected in real time by the detection device, so that a motion trajectory of the target object is subsequently determined according to point clouds in the point cloud data frames, and position detection of the target object is made more accurate.

202. according to a distance relationship, querying from historical motion trajectories a target motion trajectory associable with the point cloud, wherein the target motion trajectory is jointly constructed from a point cloud in one or more frames of historical point cloud data;

In the present disclosure embodiment, in order to accurately distinguish point clouds corresponding to the target object, so as to update a motion trajectory of the target object by using the point clouds and acquire position information of the target object in the target space, a target motion trajectory associable with the point cloud may be queried from historical motion trajectories according to distance relationships between the point cloud and the motion trajectories, so that the corresponding motion trajectory is updated by using the point cloud in the subsequent step, and the position information of the target object is accurately acquired.

The distance relationship may be a spatial relationship between the point cloud and respective historical motion trajectories, including but not limited to a Euclidean distance relationship, a Mahalanobis distance relationship, etc.

The historical motion trajectory may be a motion trajectory created and stored in the target space before a current time; the number of historical motion trajectories may be one or more. It may be understood that, if no point cloud in the target space is acquired or no motion trajectory is created before the current time, the number of historical motion trajectories at the current time is zero. The historical motion trajectory includes a motion trajectory of the target object and/or a motion trajectory of a false target.

specifically, a motion trajectory is jointly constructed from point clouds in one or more frames of historical point cloud data frames, each target object corresponds to one motion trajectory in the target space, and as long as the target object is in the target space, the motion trajectory corresponding to the target object always exists. After the acquired point cloud data frame of a current frame is obtained, since it may not be directly judged which historical motion trajectory the point cloud in the point cloud data frame is associated with, a spatial distance between each point cloud and each historical motion trajectory in the target space is calculated, and then the point cloud and the historical motion trajectory that are closest in distance are associated according to the distance relationship between the point cloud and the historical motion trajectory, so as to determine a target motion trajectory associated with the point cloud.

In some implementations, in addition to detecting a distance between the point cloud and the historical motion trajectory, the detection device further needs to compare the distance value between the point cloud and the historical motion trajectory with a preset distance threshold, so as to determine a target motion trajectory of the point cloud.

For example, step 202 may include:
(202.1) determining the distance relationship based on distance values between the point cloud and respective historical motion trajectories;
(202.2) when, based on the distance relationship, a historical motion trajectory whose distance value is smaller than a preset distance threshold is found, determining the historical motion trajectory having the smallest distance value as the target motion trajectory, and associating the point cloud with the target motion trajectory.

The preset distance threshold may be a minimum distance value at which the point cloud and the historical motion trajectory may establish an association relationship. If a distance between the point cloud and the historical motion trajectory is greater than the preset distance threshold, the point cloud and the historical motion trajectory may not establish an association.

Specifically, a point cloud data frame may contain a plurality of point clouds, and the number of historical motion trajectories may be one or more. After the point cloud data frame is acquired, a distance value between each point cloud in the point cloud data frame and each historical motion trajectory is calculated respectively. Specifically, a Mahalanobis distance value between the point cloud and the historical motion trajectory may be calculated. The calculation manner of the Mahalanobis distance value is specifically as follows:

$$\begin{matrix}{\tilde{V}}_{k + 1} ( γ ) = {[ {Z}_{c} ( k + 1 ) - {Z}_{c} ( k + 1 \vert k ) ]}^{′} {S}^{- 1} ( k + 1 ) [ {Z}_{c} ( k + 1 ) - {Z}_{c} ( k + 1 \vert k ) ] \\ = {v}_{c}^{′} ( k + 1 ) {S}^{- 1} ( k + 1 ) {v}_{c} ( k + 1 ) ;\end{matrix}$$

wherein a measurement value Z_{c}(k+1) is a candidate echo, Z_{c}(k+1|k) is a predicted value of the measurement, and S(k+1) is a covariance of an innovation v_{c}(k+1). For each point cloud, if a distance value between the point cloud and a historical motion trajectory is smaller than a preset distance threshold, it is indicated that a possible association relationship exists between the point cloud and the historical motion trajectory, and at this time, the historical motion trajectory having the smallest distance value with the point cloud is determined as a target motion trajectory of the point cloud.

Taking a radar device as an example of the detection device, since indoors are easily affected by factors such as placement of objects and facilities, walls and object movement, a signal propagation environment of the radar device indoors is much more complex than that outdoors, which results in that modeling of signal propagation of the radar device indoors may not be considered only from the angle of free signal propagation. In an indoor propagation environment, signals generate a multipath effect, and propagation delay, signal strength and characteristics of materials contacted by signal propagation of the multipath effect are greatly related, and meanwhile, indoor human activities and related factors all change actual conditions of signal propagation. In addition, generally, an indoor area is small, and target point cloud data loss caused by occlusion and insufficient angular resolution exists. Under the influence of many uncertain factors, it is extremely important to accurately complete motion trajectory tracking of a plurality of target objects in a target space. By simultaneously associating moving point clouds and static point clouds with corresponding motion trajectories, through a characteristic that the moving point clouds have fewer false targets and a characteristic that the static point clouds may detect subtle movements, accuracy of motion trajectory tracking is ensured. It is noted that, on one hand, in the present disclosure, the point cloud is directly associated with the historical motion trajectory, and compared with a manner of associating the point cloud with the historical motion trajectory after clustering the point cloud, when facing some relatively discrete point clouds, such point clouds are not ignored due to incapability of clustering, so that utilization rate of the point clouds is improved, and position information of the target object may be acquired more accurately; on the other hand, a method of directly associating the point cloud with the motion trajectory may solve problems such as incapability of measuring all target objects due to a temporary occlude and low angular resolution, and meanwhile, compared with a traditional association method of associating the point cloud with the historical motion trajectory after clustering the point cloud, the method of directly associating the point cloud with the historical motion trajectory may avoid a case that the detection device clusters point clouds of a plurality of target objects into one point cloud, and improves accuracy of motion trajectory tracking.

Illustratively, as shown in FIG. 6, a radar device detects a total of 1 point cloud A1 in a frame of point cloud data frame, and three historical motion trajectories p1, p2 and p3 exist in a target space, and a preset distance threshold is Min R. The point cloud A1 is not associated with any historical motion trajectory at the beginning, the historical motion trajectories p1, p2 and p3 are selected sequentially, distance values between the point cloud A1 and the historical motion trajectories p1, p2 and p3 are calculated to be R1, R2 and R3 respectively, and after calculation and comparison, R1 is the smallest, and then R1 is compared with the preset distance threshold Min R, and if R1<Min R, it is determined that the point cloud A1 is associated with the historical motion trajectory p1, and the historical motion trajectory p1 is subsequently tracked by using the point cloud A1. If the radar device detects a total of a plurality of point clouds in a frame of point cloud data frame, the above procedure is performed for each point cloud to determine historical motion trajectories with which respective point clouds may be associated.

Through the above manner, a target motion trajectory associable with the point cloud may be queried from historical motion trajectories according to the distance relationship between the point cloud and the motion trajectory, so that the corresponding motion trajectory is updated by using the point cloud in the subsequent step, and the position information of the target object is accurately acquired.

203. calculating a target trajectory point of the target motion trajectory, based on a point cloud associable with the target motion trajectory;

In the present disclosure embodiment, in order to accurately update a position of a motion trajectory of the target object in the target space, after the point cloud is associated with a corresponding target historical motion trajectory, the point clouds associable with the target motion trajectory are configured to calculate a trajectory point of a current frame of the target motion trajectory, so that the target motion trajectory of the current frame is updated, so as to subsequently acquire position information of the target object according to the target motion trajectory of the target object.

Specifically, after the detection device associates point clouds in the point cloud data frame with corresponding historical motion trajectories according to spatial distance relationships and obtains target motion trajectories corresponding to the point clouds, position information and speed information of the point clouds are configured to calculate extension points of the target motion trajectories, i.e., trajectory points of the current frame of the target motion trajectories are calculated, including but not limited to coordinate positions and speed information of the trajectory points. Thereby, a movement direction of the motion trajectory of the target object may be accurately obtained by using the point clouds.

In some implementations, the detection device may calculate a first predicted trajectory point corresponding to a point cloud in a current point cloud data frame associable with the target motion trajectory according to a tracking filter algorithm, calculate a second predicted trajectory point based on a historical target trajectory point of a previous frame, and finally calculate the first predicted trajectory point and the second predicted trajectory point according to a preset weight ratio to obtain a target trajectory point of the target motion trajectory.

For example, step 203 may include:
(203.1) calculating, through a tracking filter algorithm, a first predicted trajectory point corresponding to point clouds in a current point cloud data frame associable with the target motion trajectory;
(203.2) determining, from the target motion trajectory, a historical target trajectory point of a previous frame, and calculating, based on the historical target trajectory point, a second predicted trajectory point corresponding to the point cloud;
(203.3) calculating the first predicted trajectory point and the second predicted trajectory point according to a preset weight ratio to obtain a target trajectory point of the target motion trajectory.

The first predicted trajectory point may be a trajectory point predicted for the target motion trajectory associated with the current point cloud by the tracking filter algorithm.

The second predicted trajectory point may be a trajectory point of the current frame predicted according to coordinate information and speed information in the historical motion trajectory point of the previous frame.

Specifically, after the target motion trajectory determines the point cloud associated therewith, a tracking filter algorithm is adopted to perform coordinate prediction and speed prediction on respective sampling points in the point cloud acquired in the current frame, so as to obtain the first predicted trajectory point of the target motion trajectory, the first predicted trajectory point being a predicted position of the target object through the point cloud of the current frame; then, a historical target trajectory point acquired in the previous frame is acquired from the target motion trajectory, and according to the coordinate information and the speed information of the historical target trajectory point, a movement position of the target motion trajectory of the current frame is predicted, i.e., the second predicted trajectory point is obtained. After the first predicted trajectory point and the second predicted trajectory point are acquired, the first predicted trajectory point and the second trajectory point are calculated according to a preset weight ratio to obtain a target trajectory point of the target motion trajectory of the current frame. Specific tracking filtering includes the following steps:
1. One step prediction of an observed value of a state, wherein Fₖ is a state transition matrix:

$${\hat{x}}_{k \vert k - 1} = {F}_{k} {\hat{x}}_{k - 1 \vert k - 1} + {B}_{k} {u}_{k}$$

2. One step prediction of a covariance, wherein Qₖ is system noise:

$${P}_{k \vert k - 1} = cov ( {\hat{x}}_{k \vert k - 1} ) = {F}_{k} {P}_{k - 1 \vert k - 1} {F}_{k}^{t} + {Q}_{k}$$

3. Calculating an innovation covariance, wherein Hₖ is an observation matrix and Rₖ is observation noise:

$${S}_{k} = {H}_{k} {P}_{k \vert k - 1} {H}_{k}^{t} + {R}_{k}$$

4. Updating an observation noise covariance matrix Rₖ, the observation noise covariance matrix Rₖ being a covariance matrix calculated from point clouds associated with the trajectory and obtained by smoothing and filtering a previous observation matrix through an alpha filter.

$${R}_{k} = α {\hat{R}}_{k} + ( 1 - α ) {R}_{k - 1}$$

5. Calculating a Kalman filter gain:

$${K}_{k} = {P}_{k \vert k - 1}^{T} {H}_{k}^{T} {S}_{k}^{- 1}$$

6. State updating, outputting an estimated value of Kalman filtering, wherein yₖ is a residual:

$${\hat{x}}_{k \vert k} = {\hat{x}}_{k \vert k - 1} + {K}_{k} {y}_{k}$$

7. Covariance updating, I being a unit matrix:

$${P}_{k \vert k} = ( I - {K}_{k} {H}_{k} ) {{P}_{k \vert k - 1} ( I - {K}_{k} {H}_{k} )}^{t} + {K}_{k} {R}_{k} {K}_{k}^{t} .$$

Illustratively, in a target space, a motion trajectory of a target object AA is tracked through point clouds, noise of the point clouds of the target object AA is removed by using a Kalman filter and prediction is performed, and coordinates (0,1,0) of a first predicted trajectory point of a target motion trajectory of the target object AA are obtained; the target motion trajectory of the target object AA is smoothed by using an alpha filter, and according to a historical target trajectory point of a previous frame of the target motion trajectory, coordinates (0,3,0) of a second predicted trajectory point of the current frame are predicted, and if a preset weight ratio is 1:1, according to the first predicted trajectory point and the second predicted trajectory point, coordinates (0,2,0) of a target trajectory point of the target motion trajectory of the current frame may be calculated.

Through the above manner, a trajectory point of the current frame of the target motion trajectory may be calculated by using the point cloud associated with the target motion trajectory, so that the target motion trajectory of the current frame is updated, and position information of the target object is subsequently acquired according to the target motion trajectory of the target object. Moreover, the observation noise covariance matrix is smoothed and filtered by using the alpha filter, so that the situation of maneuvering target tracking may be better adapted to in a target tracking process (for example, a person suddenly stops, suddenly turns, or suddenly walks in a reverse direction while walking).

204. extending the target motion trajectory to a corresponding target trajectory point, to obtain motion trajectory data;

In the present disclosure embodiment, in order to accurately acquire position information of the target object and better track the motion trajectory of the target object, the target motion trajectory may be extended to the corresponding target trajectory point to obtain motion trajectory data, so that the position information of the target object in the target space is accurately acquired.

The motion trajectory data may be position data of a current target object reflected by the motion trajectory, including but not limited to coordinate data, speed data, etc.

Specifically, after calculating a target trajectory point of a target motion trajectory of a target object, a detection device extends the target motion trajectory to a position of the target trajectory point to obtain a target motion trajectory of a current frame, and determines motion trajectory data of the target motion trajectory of the target object in the target space.

Through the above manner, the motion trajectory data may be obtained by extending the target motion trajectory to the corresponding target trajectory point, so that the position information of the target object in the target space is accurately acquired, and loss of the motion trajectory of the target object is prevented.

205. determining position information of the target object in the target space, based on the motion trajectory data;

In the present disclosure embodiment, in order to accurately acquire position information of the target object in the target space, motion trajectory data in a current motion trajectory of the target object may be configured to determine the position information of the target object in the target space, so that current position information of the target object is accurately acquired.

Specifically, after a target motion trajectory of the target object is determined according to a point cloud of the target object in a current point cloud data frame, coordinate information, speed information and the like of the target object in the target space are determined by using the motion trajectory data of the target motion trajectory, i.e., the position information of the target object in the target space is acquired.

In some implementations, after the detection device acquires the position information of the target object in the target space, the position information of the target object needs to be sent to a display terminal of a terminal, so that the target detection page of the display terminal displays in real time a position marker of the target object.

For example, after step 205, the method may further include:
sending the position information to the display terminal, so that the display terminal displays in real time in the target detection page a position marker corresponding to the target object based on the position information.

Specifically, after detecting the position information of the target object in the target space, the detection device needs to send the position information of the target object to the terminal in real time, so that the terminal updates in real time the position marker of the target object in the target detection page of the display terminal, and visualizes the position of the target object in the target space.

Through the above manner, the position information of the target object in the target space may be determined by using the motion trajectory data in the current motion trajectory of the target object, so that current position information of the target object is accurately acquired.

In some implementations, if no historical motion trajectory exists in the target space at a current time, or a point cloud in a point cloud data frame may not be associated with any historical motion trajectory in the target space, a target data point cloud may be selected from the point clouds, and a target motion trajectory is created through the target point cloud and point clouds within a preset distance range of the target point cloud, so that a new associable motion trajectory is created for the point cloud. Specifically, the target detection method may further include:
(A.1) when, based on the distance relationship, no historical motion trajectory associable with the point cloud is found, determining, from a point cloud in the point cloud data frame that is not associated with historical motion trajectories, a target data point cloud that has a largest number of point clouds within a preset distance range thereof;
(A.2) creating a target motion trajectory based on the target data point cloud and the point clouds within the preset distance range thereof.

Specifically, after the detection device calculates distances between point clouds in the point cloud data frame and respective historical motion trajectories, if no association relationship may be established between the point clouds and all historical motion trajectories in the target space, it is indicated that the point clouds are highly likely to belong to a new target object newly appearing in the target space, and at this time, a target data point cloud needs to be determined from point clouds in the point cloud data frame that are not associated with historical motion trajectories in the target space, and the target data point cloud needs to be a point cloud having the largest number of point clouds within a preset distance range among point clouds that are not associated with historical motion trajectories in the target space, because the larger the number of point clouds within the preset distance range of the point cloud is, the more the point cloud may represent a real target object. Coordinate information, speed information and signal to noise ratio information of the target data point cloud and point clouds within the preset distance range thereof are acquired, a coordinate mean value, a speed mean value and a signal to noise ratio mean value are calculated to obtain a centroid, and the centroid is used as a starting point of a new motion trajectory to create a new motion trajectory, i.e., a new target motion trajectory is created based on the selected target data point cloud and point clouds within the preset distance range thereof.

In some implementations, the point cloud data frame includes moving point clouds acquired by a moving target detection scheme and static point clouds acquired by a static target detection scheme, and the characteristic that the moving point clouds have fewer false targets may be utilized to select the target data point cloud from the point cloud data frame, so that a subsequently created motion trajectory effectively suppresses false targets. For example, step (A.1) may include:
(A.1.1) selecting, from point clouds in the point cloud data frame that are not associated with historical motion trajectories, the moving point clouds;
(A.1.2) determining a first point cloud quantity corresponding to each moving point cloud, and identifying moving point clouds whose first point cloud quantity is greater than a preset moving point number threshold as candidate moving point clouds, wherein the first point cloud quantity is a number of moving point clouds within a preset range of the moving point clouds;
(A.1.3) determining a second point cloud quantity of each candidate moving point cloud, and identifying candidate moving point clouds whose second point cloud quantity is greater than a preset static point number threshold as pending data point clouds, wherein the second point cloud quantity is a number of static point clouds within the preset range of the candidate moving point cloud;
(A.1.4) determining a total point cloud quantity of each pending data point cloud, and identifying the pending data point cloud having the largest total point cloud quantity as the target data point cloud, wherein the total point cloud quantity is a sum of the first point cloud quantity and the second point cloud quantity.

The moving point clouds may be point clouds acquired by the moving target detection scheme in the point cloud data frame, and the static point clouds may be point clouds acquired by the static target detection scheme in the point cloud data frame.

Specifically, when no motion trajectory associable with the point clouds exists in the target space, a new motion trajectory needs to be created for the point clouds. In order to avoid negative effects brought by false point clouds, the characteristic that the moving point clouds have fewer false point clouds may be utilized to select the moving point clouds from point clouds in the point cloud data frame that are not associated with historical motion trajectories, and respective moving point cloud quantities within preset ranges of the moving point clouds are acquired, i.e., first point cloud quantities are acquired, and moving point clouds whose first point cloud quantities are greater than a preset moving point number threshold are identified as candidate moving point clouds, so that selected candidate moving point clouds have enough point clouds around to prove that the moving point clouds are real point clouds of the target object rather than point clouds of ghosts and other false targets. Then, respective candidate moving point clouds are used as centers to acquire numbers of static point clouds within preset ranges thereof, i.e., second point cloud quantities, and if the second point cloud quantities of the candidate moving point clouds are greater than a preset static point number threshold, the candidate moving point clouds may be directly considered as real moving point clouds rather than point clouds of ghosts and other false targets, and the candidate moving point clouds are identified as pending data point clouds. The first point cloud quantities and the second point cloud quantities of the pending data point clouds are added to obtain total point cloud quantities of the pending data point clouds, and the pending data point cloud having the largest total point cloud quantity is identified as the target data point cloud.

Through the above manner, the target data point cloud may be selected from the point clouds, and a new target motion trajectory is created through the target point cloud and point clouds within the preset distance range thereof, current position information of a new target object is determined based on the new target motion trajectory, and position information of the target object in the target space is better tracked subsequently. The new target motion trajectory created at the current time and/or the updated target motion trajectory serve as historical motion trajectories of a next point cloud data frame.

In some implementations, when a certain target object leaves the target space, a motion trajectory corresponding to the target object in the target space needs to be deleted, i.e., the motion trajectory of the target object no longer serves as a historical motion trajectory of a next frame.

In an implementation, a plurality of frames of point cloud data frames may be acquired within a preset time, and if the number of times the target motion trajectory is associated within the preset time and/or the frequency of being associated with moving point clouds does not satisfy a preset condition, it is determined by default that the target object corresponding to the target motion trajectory is no longer in the target space, and the target motion trajectory is deleted. Specifically, the target detection method may further include:
(B.1) within a preset time, acquiring a plurality of frames of point cloud data frames, and when detecting that the number of frames in which the target motion trajectory is associated within the preset time is smaller than a preset frame number threshold, deleting the target motion trajectory;
(B.2) and/or, when detecting that, within the preset time, the frequency at which the target motion trajectory is associated with moving point clouds in the point cloud data frame is smaller than a preset frequency threshold, deleting the target motion trajectory, wherein the point cloud data frame includes moving point clouds acquired by the moving target detection scheme and static point clouds acquired by the static target detection scheme.

Specifically, a plurality of frames of point cloud data frames are continuously acquired within the preset time. When the number of frames in which the target motion trajectory is associated (associated with moving point clouds or static point clouds) within the preset time is greater than a preset frame number value, it may be indicated that the target object corresponding to the target motion trajectory continuously exists in the target space within the preset time, so that a plurality of point cloud data frames associated with the target object are acquired; similarly, within a continuously detected preset time, if the frequency at which the target motion trajectory of the target object is associated with moving point clouds in the point cloud data frame is greater than a preset frequency threshold, it is also indicated that the target object exists in the target space within the preset time, so that moving point clouds of the target object are detected in the target space. Therefore, when it is detected that the number of frames in which the target motion trajectory is associated within the preset time is smaller than the preset frame number threshold, or the frequency at which the target motion trajectory is associated with moving point clouds in the point cloud data frame within the preset time is smaller than the preset frequency threshold, it is indicated that the target object corresponding to the target motion trajectory is no longer in the target space, so that point cloud information related to the target object cannot be detected in the target space, and at this time, the target motion trajectory corresponding to the target object in the target space needs to be deleted.

Through the above manner, a plurality of frames of point cloud data frames may be acquired within the preset time, and if the number of times the target motion trajectory is associated within the preset time and/or the frequency of being associated with moving point clouds does not satisfy the preset condition, it is determined by default that the target object corresponding to the target motion trajectory is no longer in the target space, and the target motion trajectory is deleted, so that information assistance is provided for subsequently synchronously deleting the position marker corresponding to the target object in the target detection page in the terminal, negative effects on visualization of the position of the target object are avoided, and a user may more accurately understand conditions in the target space.

To facilitate understanding of the embodiments of the present disclosure, an application scenario example of the embodiments of the present disclosure is described below. Specifically, the application scenario example is described by performing the above steps 201-203 and with reference to FIGS. 4-7.

An application scenario example of the embodiments of the present disclosure is applicable to target detection scenarios such as smart homes, parking lots, and indoor gyms. For ease of understanding, the embodiments of the present disclosure are described by taking a smart home scenario as an example, and the smart home target detection scenario is specifically as follows:

The user may view in real time, through the target detection page of the APP on the terminal, a position marker of a target object in the target space, wherein the page position of the position marker is determined based on position information of the target object in the target space, the position information being determined by motion trajectory data of the target object in the target space; when any target object moves into a monitoring region within the target space where an automation control scheme is set, the information display page in the target detection page displays corresponding time information and the status of the automation control scheme; in this way, not only may the position information of the target object be accurately acquired by using the motion trajectory of the target object, but visual service for the target space is also provided to the user, improving user experience.

The smart home target detection scene of the present disclosure may be implemented by a terminal and a detection device, with the specific procedure as follows:
(1) A target detection procedure of interface interaction of a terminal is as follows:
(1.1) After a target detection application in the terminal is opened, a target detection page is displayed, which may be regarded as an initial page. The target detection page includes an information display page and a monitoring page. The monitoring page includes a pre-set monitoring region for responding to an automation control scheme. If a target object appears in the target space, the monitoring page in the target detection page displays a position marker corresponding to the target object.
(1.2) When a position marker of any target object first appears in the monitoring region, or all position markers leave the monitoring region, an information display instruction of the information display page is triggered. As shown in FIG. 4, five position markers exist in the monitoring region, corresponding to five target objects in the target space. The information display page displays that a person is in the monitoring region at 17:46, and a related automation control service is triggered, i.e., luminance is adjusted to 334 lux.
(2) Taking a radar device as an example of a detection device, and with reference to FIGS. 6 and 7, a position information detection procedure of a target object on the detection device side is as follows:
(2.1) As shown in FIG. 7, after the radar device is powered on, the radar device may collect in real time point cloud data frames in the target space, each point cloud data frame containing at least one point cloud, i.e., point cloud input is performed.
(2.2) If historical motion trajectories exist in the target space, distance values between point clouds in the point cloud data frame and the respective historical motion trajectories are calculated. As shown in FIG. 6, distance values R1, R2 and R3 between a point cloud A1 and historical motion trajectories p1, p2 and p3 are calculated respectively, wherein R1 is the smallest and satisfies R1<Min R, so that the point cloud A1 is associated with the historical motion trajectory p1, and the historical motion trajectory p1 is tracked by using the point cloud A1. It is noted that each historical motion trajectory corresponds to one target object, and the radar device may track the historical motion trajectory through the point cloud associated with the historical motion trajectory, acquire motion trajectory data of the historical motion trajectory, and obtain latest position information of the target object corresponding to the historical motion trajectory.
(2.3) If no historical motion trajectory exists in the target space, or point clouds in the point cloud data frame cannot be associated with any historical motion trajectory in the target space, a target data point cloud is selected from the point clouds, and a new target motion trajectory is created by using the target data point cloud and all point clouds within a preset range thereof. It is noted that the target data point cloud is a moving point cloud acquired by the moving target detection scheme in the point cloud data frame, and the target data point cloud has the largest number of point clouds within the preset range.
(2.4) The historical motion trajectory is tracked through the point cloud associated with the historical motion trajectory, a target trajectory point of the historical motion trajectory is predicted, the historical motion trajectory is extended to the target trajectory point, and motion trajectory data of a current frame is obtained.
(2.5) If the radar device detects that the target object leaves the target space, i.e., the motion trajectory of the target object in the target space is terminated, the motion trajectory is deleted.
(2.6) The radar device determines position information of the target object in the target space according to motion trajectory data of a motion trajectory corresponding to the target object in a current frame, and uploads the position information of the target object to a cloud server in real time, and the cloud server sends the position information of the target object to the terminal, so that the terminal displays position markers of respective target objects in the target detection page according to position information corresponding to the respective target objects.

Through the above application scenario example, the following effects may be achieved: positions of target objects in the target space are viewed in real time through the target detection page in the terminal, a status of an automation control service triggered by the target object in a monitoring region in the target space is recorded and displayed, and time information of the target object in the monitoring region is displayed. Point clouds in the target space are detected by the radar device, and point clouds associated with the motion trajectory of the target object are configured to calculate current position information of the target object, so that accuracy of position detection of the target object is improved.

It may be known from the above that, in the embodiments of the present disclosure, a target detection page may be displayed; position information of a target object in a target space may be acquired, wherein the position information is determined by motion trajectory data of the target object in the target space; and a position marker corresponding to the target object may be displayed in real time in the target detection page, wherein a page position of the position marker is determined based on the position information of the target object in the target space. Therefore, after the target detection page is displayed on the terminal, the position information of the target object in the target space is accurately determined according to the motion trajectory data of the target object, so as to avoid confusion of position information caused by too close distances among a plurality of target objects in the target space, and the position marker of the target object is displayed in real time in the target detection page according to the position information, so as to provide visual service for a user. In this way, the motion trajectory of the target object is updated according to point cloud data in the target space, so that the position information of each object is accurately acquired according to the motion trajectory, and the user experience is improved.

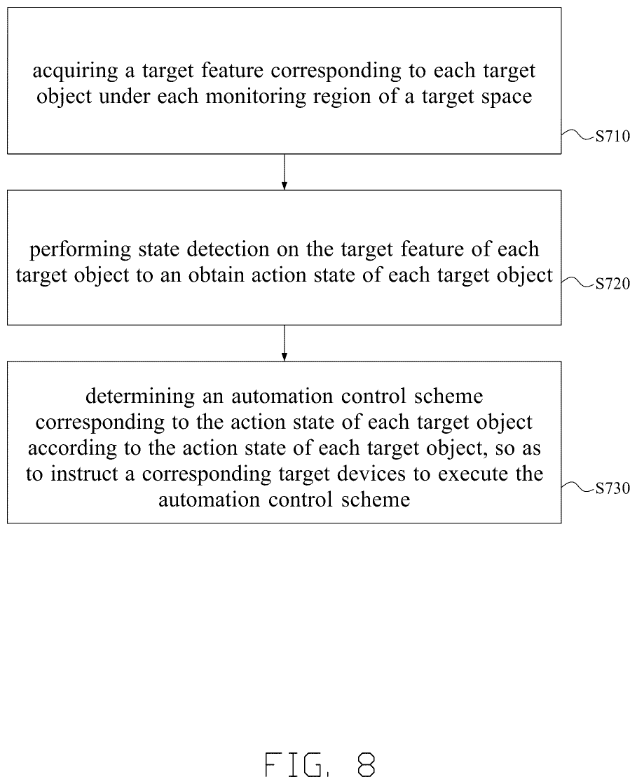

As shown in FIG. 8, an embodiment of the present application provides a device control method, and the device control method of the embodiment of the present application may be performed by a computer device. It may be understood that the computer device may specifically be the sensor in FIG. 1, or may be a gateway device, etc.

As shown in FIG. 8, the device control method of the embodiment of the present application specifically includes the following steps:
S710. acquiring a target feature corresponding to each target object under each monitoring region of a target space.

The target space is a space having a boundary range, and partial areas are divided out of the target space in a custom manner to serve as monitoring regions. The target space may include a plurality of monitoring regions. For example, the target space includes an entire house, and the monitoring regions are respective rooms in the house. The target object includes but is not limited to a person or a living animal. The target features are features corresponding to the target object, and may be, for example, position features of body parts or motion features of limbs, etc. For example, the target object is a human body, and the target features may be position features of a head and position features of hips. For example, if the head is located on the ground and/or the hips are located on the ground within a preset fall duration, an action state is fall. By acquiring the target features, a foundation is laid for subsequently acquiring an action state of the target object based on the target features.

Specifically, a computer device acquires target features corresponding to each target object under each monitoring region in the target space. The computer device may acquire an electromagnetic wave signal of the target object in an electromagnetic wave manner, and determine the target features based on the electromagnetic wave signal.
S720. performing a state detection on the target feature of each target object to an obtain action state of each target object.

The action states are states of motions of the target object, including walking, falling, static, micro motion and running, etc. For example, walking: horizontal movement of the target object within a preset walking duration; falling: a partial body feature of the target object contacts the ground within a preset fall duration; static: the target object keeps static at a certain position within a preset static duration; micro motion: movement of the target object within a preset distance range within a preset micro motion duration. It should be understood that one or more target objects may exist in each monitoring region, or no target object may exist.

Specifically, the computer device performs state detection on the target features of each target object to obtain action states of each target object, so that a subsequent automation control scheme is obtained according to the action states of the target object, and a target device corresponding to a monitoring region where the target object is located is controlled according to the automation control scheme.
S730. determining an automation control scheme corresponding to the action state of each target object according to the action state of each target object, so as to instruct a corresponding target device to execute the automation control scheme.

The target devices are devices corresponding to the monitoring regions, and the devices include an air conditioner, a refrigerator, a lamp, a sweeping robot, a range hood, etc. For example, the monitoring region is a kitchen, and target devices include a kitchen lamp, the range hood and a dish washer, etc. The automation control scheme is a scheme for controlling a target device corresponding to a monitoring region and executing a corresponding action/operation.

The automation control scheme includes a trigger condition, a controlled target device and an execution action. When the action state of the target object in the monitoring region satisfies the trigger condition, the computer device executes a target action on the target device corresponding to the monitoring region, so that automatic operation of the target device is realized. The target device controlled by the automation control scheme may be in the monitoring region. For example, the monitoring region is a rest area, and the automation control scheme is to control brightness of a lamp in the rest area according to action states of at least one target object in the rest area. Certainly, the target device controlled by the automation control scheme may also be outside the monitoring region. For example, the monitoring region is a porch, and a corresponding automation control scheme is: controlling on/off of a lamp of the porch and controlling on/off of an air conditioner in a living room according to action states of at least one target object in the porch.

Specifically, the computer device determines automation control schemes corresponding to the action states of each target object according to the action states of each target object, and then instructs corresponding target devices to execute the automation control schemes according to the automation control schemes.

The embodiments of the present application implement determining a control scheme of a target device corresponding to a monitoring region according to the action state of at least one target object located in the monitoring region, and further implement control of the target device. For example, the monitoring region is a rest area, and the action states of the respective target objects are static states. The automation control scheme corresponding to the static state is to dim the lamp of the rest area. In this way, a user does not need to manually adjust brightness of the lamp, and user experience is improved.

In the technical solution of the embodiments of the present application, the computer device acquires target features corresponding to each target object under each monitoring region of the target space, performs state detection on the target features of the respective target objects to obtain the action states of the respective target objects, determines automation control schemes corresponding to the action states of the respective target objects according to the action states of the respective target objects, and further controls target devices corresponding to the monitoring regions according to the automation control schemes, so as to implement control of the target devices. The technical solution of the embodiments of the present application implements control of actions of target devices corresponding to the monitoring regions according to the action states of at least one target object in the monitoring regions, so that flexibility of control of the target devices is improved. Since the automation control schemes are determined according to the action states of the target objects, accuracy of control of the target devices is improved.

In another embodiment, acquiring the target feature corresponding to each target object under each monitoring region of the target space includes: acquiring a target signal corresponding to each target object under each monitoring region of the target space; performing feature extraction on the target signal to obtain the target feature corresponding to the respective target object; and performing the state detection on the target feature of the respective target objects, to obtain the action state of each target object includes: respectively performing state classification processing on the target feature of each target object to obtain the action state of each target object.

The target signals may be radar electromagnetic wave signals. The target features are features obtained based on the radar electromagnetic wave signals.

Specifically, the computer device acquires target signals corresponding to each target object under each monitoring region, and performs feature extraction on the target signals to obtain target features corresponding to the respective target objects. When the target signals are radar electromagnetic wave signals, the computer device converts the radar electromagnetic wave signals into micro Doppler signals, and performs feature extraction on the converted micro Doppler signals to obtain the target features. State classification processing is respectively performed on the target features of the respective target objects to obtain the action states of the respective target objects.

In an embodiment, the computer device performs state classification processing on the target features of the respective target objects through a pre trained classification model to obtain the action states of the respective target objects. The classification model may be a naive Bayes classifier, a logistic regression model, a decision tree classification model, a random forest classification model, a K-nearest neighbor classification model, a support vector machine model, etc. The radar electromagnetic wave signals of the target object acquired through radar may describe the target object more accurately, so that information of subsequently obtained target features of the target object is richer, and accuracy of action states determined according to the target features is further improved.

In an embodiment, the target signal includes a radar signal; and the step of performing feature extraction on the target signals to obtain target features corresponding to the respective target objects may include: performing Doppler feature extraction on a radar signal corresponding to the respective target object to obtain a Doppler feature corresponding to the radar signal; the Doppler feature includes at least one of motion intensity, frequency, motion period, Doppler bandwidth and Doppler offset; and obtaining a target feature corresponding to the respective target object according to the Doppler feature.

In an embodiment, radar electromagnetic wave signals in the respective monitoring regions of the target space are acquired by using a millimeter wave radar sensor, and no limitation is imposed on frequency bands and structures of the millimeter wave radar. When detecting that a target object enters a monitoring region, the computer device extracts the radar electromagnetic wave signals of the target object, and acquires at least an abscissa and an ordinate of the target object that are parallel to a horizontal plane. Micro Doppler signal conversion is performed on the radar electromagnetic wave signals of each target object, and feature extraction is performed on the micro Doppler signals.

Illustratively, within a detection period of t seconds, the computer device acquires position information of the target object, marked as (x, y), continues to calculate a speed Doppler of the radar electromagnetic wave signals of the target object, marked as S1, continues to count for a period of time of T seconds, speed Doppler is accumulated from S1 to SN, and a Doppler time spectrogram, i.e., a micro Doppler spectrogram, is obtained.

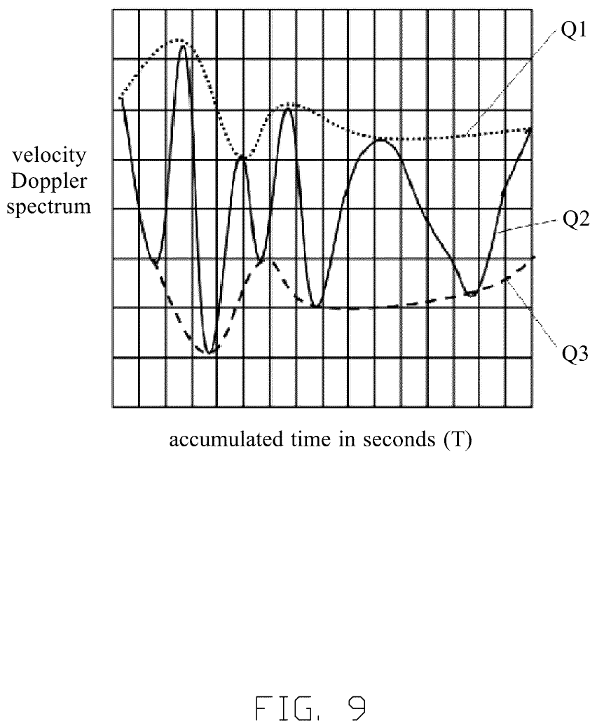

As shown in FIG. 9, a maximum value of each column of data is taken to form a waveform curve Q2 in the figure, representing a main frequency change of the target object, expressed as S(n), one piece of data is acquired every t seconds, N pieces of data are accumulated within T seconds, discrete Fourier transform (FFT) operation is performed on the accumulated data, intensity P1 corresponding to a maximum value of the spectrum signal and a corresponding frequency F1 are acquired, intensity of a second largest peak value is P2 and a corresponding frequency is F2, and a motion period of the target object ΔF=|F1−F2| is obtained.

Peak values of the waveform curve Q2 are acquired to form an upper envelope curve Q1, valley values of the waveform curve Q2 are acquired to form a lower envelope curve Q3, Doppler frequencies F11 corresponding to peak values of the upper envelope curve Q1 and Doppler frequencies F12 corresponding to valley values are acquired, and Doppler frequencies F31 corresponding to peak values of the lower envelope curve Q3 and Doppler frequencies F32 corresponding to valley values are acquired. A total Doppler signal bandwidth B1=|F11−F12| of the target object is calculated, and a total Doppler offset O1=|F31−F32|/2 of the target object is calculated.

Feature vectors in a micro Doppler diagram of the target object include: 1. intensity P1 and frequency F1 of main motion Doppler of the target; 2. motion period ΔF of the target; 3. total Doppler bandwidth B1 of the target; and 4. total Doppler offset O1 of the target.

The above feature vectors are feature vectors of each action state. Target features obtained through micro Doppler signals, i.e., the feature vectors, have richer information, so that subsequently obtained action states are more accurate.

In another embodiment, performing the state detection on the target feature of the respective target objects to obtain the action states of the respective target objects includes: for the target features corresponding to each target object, respectively performing state classification processing on the target features corresponding to each target object through a trained state detection model to obtain probabilities a probability corresponding to each the action state; based on the probability of each action state, determining the action state of each target object.

The state detection model is a pre trained model for classifying target features.

Specifically, the computer device respectively performs state classification processing on the target features corresponding to the respective target objects through the trained state detection model to obtain probabilities corresponding to the respective action states, and determines the action states of the respective target objects based on the probabilities of the respective action states. In an embodiment, the computer device selects an action state corresponding to a highest probability value among probability values that the target features belong to the respective action states as an action state of a target object corresponding to the target features. In this way, the action states of the respective target objects are obtained respectively. In the embodiments of the present application, the target features of the target object are processed by using a pre trained model to obtain the action state of the target object, so that accuracy of determining the action state of the target object is improved.

In another embodiment, the state detection model is obtained through model training steps. The model training steps include: acquiring sample target features of sample target objects under different action states, and generating sample sets respectively corresponding to the action states based on the sample target features; each sample set includes positive samples for a current action state and negative samples for action states other than the current action state, and corresponding sample labels; the sample labels include sample labels for the positive samples and sample labels for the negative samples; respectively performing state detection on the sample target features in the sample sets corresponding to the action states through each branch model in an initial model to respectively obtain sample state results; and based on differences between the sample state results and the corresponding sample labels, adjusting model parameters of each branch model in the initial model and continuing training until training conditions are met, and stopping training to obtain the trained state detection model.

The initial model has classification conditions, including but not limited to a support vector machine. The training conditions may be that model parameters converge and fluctuate for several times within a preset parameter range, or the model parameters reach a preset threshold, etc.

Specifically, the computer device may acquire sample target features of sample target objects under different action states, generate sample sets respectively corresponding to the action states according to the sample target features, and each sample set includes positive samples of a current action state and negative samples of action states other than the current action state, and corresponding sample labels. For example, the current action state is falling, and the positive samples are sample target features of falling. The negative samples are sample target features of action states other than falling. The negative samples have uniquely corresponding sample labels, and the positive samples have uniquely corresponding sample labels.

The computer device respectively performs state detection on the sample target features in the sample sets corresponding to the action states through the branch models in the initial model to respectively obtain sample state results. For each sample state result, model parameters of the branch models of the initial model are adjusted according to a difference between each sample state result and a corresponding sample label, and then training is repeated. When the training conditions are satisfied, training is stopped, and the state detection model is obtained. The method of the embodiments of the present application implements training of the state detection model, and branch models are trained according to sample sets corresponding to action states, so that the finally obtained state detection model is more targeted. When an action state of a target object is determined, accuracy of determining the action state is improved.

Illustratively, taking a human body as a target object, radar electromagnetic wave signals of the target object under action states of motion, static, micro motion and falling are respectively collected. The computer device calculates micro Doppler signals under the various action states, including intensity, frequency, period, bandwidth and offset, etc. Sample sets include sample labels of four action states, and feature vectors composed of micro Doppler features corresponding to each sample label.

The labels may include {motion, static, micro motion, falling}. The feature vectors may include {intensity and frequency of motion Doppler of the target object, motion period of the target object, total Doppler bandwidth of the target object, total Doppler offset of the target object}. The sample sets are divided into a training set and a test set. In an embodiment, 80% of the sample sets are used as the training set, and 20% of the sample sets are used as the test set.

The computer device extracts a part of the training set according to the labels to train the branch models. For example, the labels include motion, static, micro motion and falling, and the part of the training set is extracted for four times.

For the first time, feature vectors corresponding to a motion label are extracted as a positive sample set, and feature vectors corresponding to static, micro motion and falling are extracted as a negative sample set; for the second time, feature vectors corresponding to a static label are extracted as a positive sample set, and feature vectors corresponding to motion, micro motion and falling are extracted as a negative sample set; for the third time, feature vectors corresponding to a micro motion label are extracted as a positive sample set, and feature vectors corresponding to static, motion and falling are extracted as a negative sample set; and for the fourth time, feature vectors corresponding to a falling label are extracted as a positive sample set, and feature vectors corresponding to static, micro motion and motion are extracted as a negative sample set.

The computer device determines the number of branch models of the initial model according to the number of motion labels, and trains the branch models by using a part of the training set corresponding to each motion label. After training of the branch models is completed, a state detection model is obtained.

Illustratively, the initial model is an SVM classifier, and an expression of the SVM classifier is:

$${w}^{T} {X}_{i} + b - 1 \geq + 1 , if {y}_{i} = + 1$$

$${w}^{T} {X}_{i} + b - 1 \leq - 1 , if {y}_{i} = - 1 ;$$

wherein Xi represents a feature vector, yᵢ represents a label result, and w and b represent parameters. w represents a normal vector of a classifier model, T represents transpose operation on the normal vector, and the normal vector is a matrix.

In order to prevent the SVM classifier from being affected by over fitting to generalization ability, a loss function is added, and model training is ended when a training result satisfies a preset fitting degree.

An expression of the loss function may be:

$$Loss = {\sum }_{i = 1}^{N} max ( 0 , 1 - {y}_{i} ( {w}^{T} {x}_{i} + b ) ) + λ {‖ w ‖}^{2} ;$$

wherein Xi represents a feature vector, yi represents a label result, (w^{T}xᵢ+b) represents an output of the model (i.e., a predicted classification result), w and b represent a normal vector and an intercept of a hyper plane, N represents the number of samples, λ is an adjustable parameter, and is configured to weigh empirical risk and structural risk, so as to increase punishment intensity of a certain item. Generally, training of the model is ended at a probability of 95%.

In order to improve accuracy of the SVM classifier, a nonlinear kernel function, i.e., a Gaussian kernel function, is used, and the expression is:

$$k ( {X}_{1} , {X}_{2} ) = exp ( - \frac{{‖ {X}_{1} - {X}_{2} ‖}^{2}}{2 {σ}^{2}} ) ;$$

X1 represents a feature vector in a positive sample set, X2 represents a feature vector in a negative sample set, k( ) represents the Gaussian kernel function, σ represents a variance between the feature vector in the positive sample set and the feature vector in the negative sample set, and expel represents acquiring a probability that a category of the positive sample set and a category of the negative sample set are on a Gaussian distribution.

The SVM classifier has a linear classifier and a nonlinear classifier. The Gaussian function is a kernel function selected in SVM classifier training, and the Gaussian kernel function may satisfy nonlinear classification. The Gaussian kernel function is a function for converting nonlinear classification to linear classification in a training model. The function may better fit the classifier.

That is, if an input item is needed for training the branch model, the Gaussian kernel function, the loss function, the feature vector and the sample label are all input items, and the purpose is to train the branch model. After training is ended, a model of y=wTXi+b may be obtained, and w and b are parameters of the model. A category y of the feature vector Xi may be obtained by inputting the feature vector Xi.

When an action state of a target object is acquired, the computer device acquires a radar electromagnetic wave signal of the target object, acquires a micro Doppler signal according to the radar electromagnetic wave signal, extracts target features in the micro Doppler signal, i.e., the feature vector, processes the feature vector through the state detection model, i.e., processes the feature vector through four trained branch models to obtain four results, and selects an action state corresponding to a result having the highest probability value as the action state of the target object.

In the embodiments of the present application, the initial model adds the loss function during training, so that the initial model is prevented from being affected by over fitting to generalization ability. In addition, the initial model uses the nonlinear kernel function, i.e., the Gaussian kernel function, so that accuracy of the classifier is improved. During training, sample sets under each action state are configured to train the branch models, so that the finally obtained state detection model is more targeted. When an action state of a target object is determined, accuracy of determining the action state is improved.

In another embodiment, determining the automation control scheme corresponding to the action state of each target object according to the action state of each target object includes: when the action state of each target object under a monitoring region of the target space satisfy a trigger condition in automation control scheme corresponding to the monitoring region, instructing a corresponding target device to execute a target action in the automation control scheme.

The trigger conditions may be set according to characteristics of the monitoring regions. For example, in a rest area, when action states of all target objects are static, corresponding electric devices are instructed to execute target actions in the automation control schemes, i.e., corresponding lamps are dimmed and/or volume of a television is lowered, etc.

Certainly, before the corresponding electric devices are instructed to execute the target actions, the computer device first judges whether the target devices satisfy conditions for executing the target actions. For example, it is first judged whether the lamp is turned on, and if the lamp is turned on, brightness or color of the lamp is adjusted. For another example, it is judged whether the television is turned on, and if the television is turned on, it is judged whether volume of the television is greater than a preset volume threshold, and if the volume is greater than the preset volume threshold, the computer device adjusts the volume to a low volume threshold, etc. The target actions are determined according to states of the target devices, and include turning on, turning off and adjusting power, etc. For example, the target device is an air conditioner, and the target actions may be turning off, turning on, adjusting temperature or adjusting a mode, etc.

Specifically, in the embodiments of the present application, the computer device judges whether the action states of the respective target objects under each monitoring region of the target space satisfy trigger conditions in automation control schemes corresponding to the monitoring regions. If yes, the computer device instructs corresponding target devices to execute target actions in the automation control schemes. In the technical solution of the embodiments of the present application, the target actions are determined according to whether the action states satisfy the trigger conditions, so that flexibility of the automation control schemes is improved, and control of target devices corresponding to the monitoring regions is more flexible.

In another embodiment, wherein the determining, according to the action state of each target object, the automation control scheme corresponding to the action state of each target object, includes: when a region type of the monitoring region and the action state of each target object, satisfy trigger condition in an automation control scheme of the monitoring region, instructing a corresponding target device, to execute a target action in the automation control scheme.

The region types may be customized according to the target space. For example, the target space is a factory, and the region types include an office, a workshop and a corridor, etc. The target space is a residential house, and the region types include a rest area, a porch, a kitchen, a washing area and a balcony, etc.

Specifically, when the region type of the monitoring region and the action states of the target objects satisfy the trigger conditions in the automation control schemes corresponding to the monitoring region, the computer device instructs the target devices to execute the target actions. The target actions are determined according to the region types and the action states of the target objects in the monitoring regions, so that the target actions are more targeted, and accuracy of control of the target devices is improved.

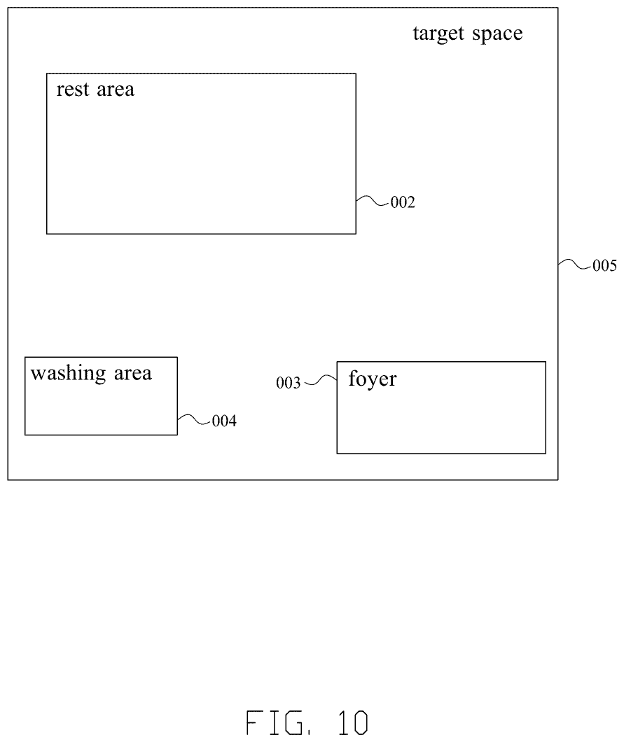

Illustratively, as shown in FIG. 10, in the embodiments of the present application, respective monitoring regions in a target space 005 are divided into three region types: a washing area 004, a porch 003 and a rest area 002. Trigger conditions include: the region type of the monitoring region is the washing area 004, and the action state is falling. Target devices corresponding to the washing area 004 include alarm devices, such as an indicator lamp, an audio device and a communication device. The communication device is configured to send a message that the target object falls to a pre bound user end. The trigger conditions further include: the region type of the monitoring region is the porch 003, and the action state is motion. When the region type of the monitoring region is the porch 003, and the action state of at least one target object in the porch 003 is motion, the computer device turns on or off the indicator lamp, and sends out voice for prompting door closing.

In an embodiment, the action states include action categories and motion directions; and the step of determining the automation control scheme corresponding to the action state of each target object according to the action state of each target object may include: determining the automation control scheme of the action state of each target object according to the action category and the motion direction of each target object.

It may be understood that the action states may include specific action categories and motion directions. The action categories may be categories of current actions of the target objects, such as walking, running, jumping, falling, micro motion, static and other action categories. The motion directions may be directions in which the target objects currently move, such as forward, backward, left, right, in place, etc. Alternatively, with specific monitoring regions as references, taking the monitoring regions including a plurality of sub monitoring regions as an example, such as sub monitoring region 1, sub monitoring region 2, sub monitoring region 3, etc. The motion directions may include moving toward the monitoring regions, moving from sub monitoring region 1 to sub monitoring region 2, moving from sub monitoring region 1 to sub monitoring region 3, etc.

The computer device judges whether the action categories and the motion directions of the respective target objects under the respective monitoring regions of the target space satisfy trigger conditions in automation control schemes corresponding to the monitoring regions. If yes, the computer device instructs corresponding target devices to execute target actions in the automation control schemes.

In the present embodiment, the target actions are determined by judging whether the trigger conditions are satisfied according to the action types and the motion directions, so that flexibility of the automation control schemes is improved, and control of target devices corresponding to the monitoring regions is more flexible.

In an embodiment, when the computer device detects that motion directions of at least one target object are toward indoors, an indicator lamp is turned on, and an audio device is controlled to send out voice for prompting door closing. When detecting that the motion directions of at least one target object are toward a door, the computer device turns off the indicator lamp, and controls the audio device to send out voice for prompting door closing. The trigger conditions further include: the region type of the monitoring region is the rest area 002, and the action state is static. Target devices corresponding to the rest area 002 include a television, a lamp in the rest area 002, an air conditioner and an audio device, etc. When the action states of all target objects in the rest area 002 are static, power of the target objects is reduced. For example, volume of the television is lowered, wind speed of the air conditioner is weakened, volume of the audio device is lowered, and brightness of the lamp is reduced, etc.

The technical solution of the embodiments of the present application may achieve targeted coping with action states of target objects in various region types, and when the action states satisfy the trigger conditions, target devices corresponding to the monitoring regions are controlled.

An embodiment of the present application provides a region monitoring method. The region monitoring method provided by the embodiment of the present application may display a status of monitoring a region of a target space, provide an interaction interface for the above device control method, and facilitate a user to observe region monitoring status. In the present embodiment, the method is applied to a computer device for illustration. It may be understood that the computer device may specifically be the terminal 11 in FIG. 2, or may be a device having a computing processing function and a display function, such as a smart control panel.

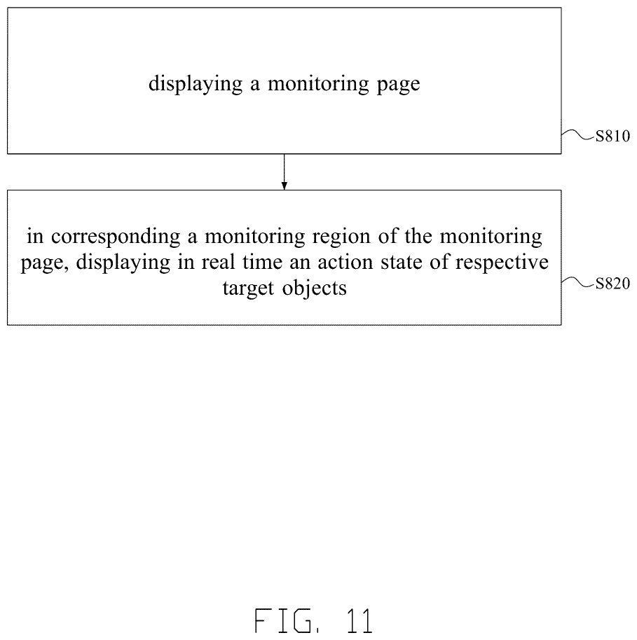

As shown in FIG. 11, the region monitoring method of the embodiment of the present application includes the following steps:
S810. displaying a monitoring page;

The monitoring page includes at least one monitoring region corresponding to the target space.

Specifically, the monitoring page is displayed in a terminal, so that a user may view the monitoring page. The terminal includes a mobile terminal, a computer or a tablet computer, etc.
S820. in corresponding a monitoring region of the monitoring page, displaying in real time an action state of respective target objects;

The action states of the respective target objects are obtained by recognizing a target feature corresponding to the respective target objects; and the action states of the respective target objects are configured to instruct corresponding target devices to execute automation control schemes corresponding to the action states.

Specifically, the computer device displays in real time the action states of the respective target objects in the corresponding monitoring regions in the monitoring page, so that the user may view the action states of the target objects at any time. Illustratively, the action states of the target objects are displayed, the target objects may be represented by object identifiers, and state identifiers of the action states are displayed beside the object identifiers.

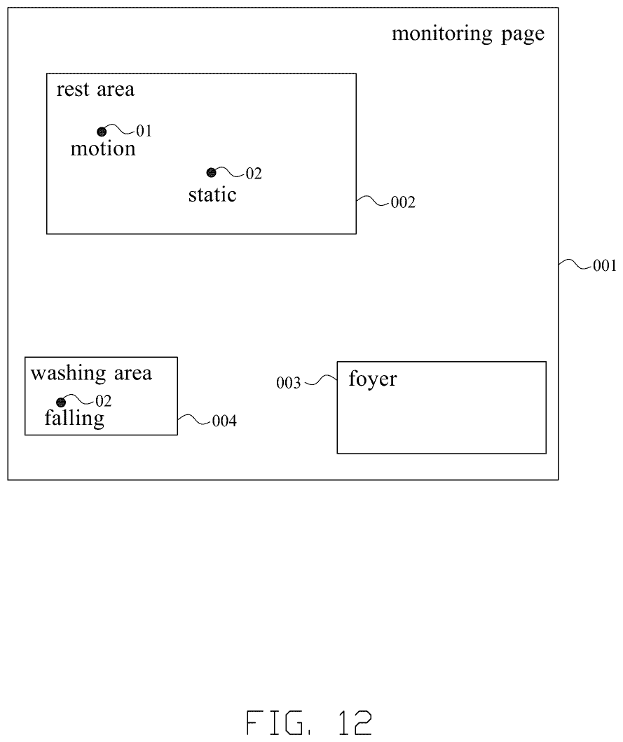

It may be understood that the object identifiers of different target objects may be the same or different. For example, “●” is used as the object identifier, and the action states are identified in a text form. As shown in FIG. 12, in a monitoring page 001, action states corresponding to the target objects are displayed below “ [symbol] ”, an action state of a target object 01 in a rest area 002 is motion, an action state of a target object 02 in the rest area 002 is static, and an action state of a target object 03 in a washing area 004 is falling, and no target object exists in a porch 003.

In the technical solution of the embodiments of the present application, the computer device displays the monitoring page, and displays in real time the action states of the respective target objects in the corresponding monitoring regions in the monitoring page, so that the user may view the monitoring page at any time to check whether target objects exist in the monitoring regions and what the action states of the target objects are, and user experience is improved.

In another embodiment, the region monitoring method further includes: displaying a region editing page; the region editing page is configured to custom configure a monitoring region of the target space; and in response to any region selected in the region editing page, generating a custom monitoring region.

Specifically, the region editing page may be configured to custom configure a monitoring region of the target space.

The computer device responds to any region in the region editing page, and generates a custom monitoring region. The region editing page and the target space have a one to one correspondence relationship, and the custom monitoring region is generated in the region editing page. The computer device responds to a selection operation on any region in the region editing page, and generates the custom monitoring region. Certainly, positions of the monitoring regions in the target space, sizes of the regions, etc. may all be set in a custom manner.

In an embodiment, a relationship between respective target devices in the target space and the monitoring regions may be set by the computer device in response to the region editing page. For example, a device A01 and a monitoring region A are associated in response to a relationship setting in the region editing page, i.e., the monitoring region A corresponds to the device A01.

In the technical solution of the embodiments of the present application, a monitoring region may be custom configured in the region editing page, so that flexibility of configuring the monitoring region is improved, and user experience is improved.

In another embodiment, the region monitoring method further includes: acquiring an execution status after a target device executes an automation control scheme corresponding to an action state; and displaying an execution status of automation control schemes of the respective monitoring regions in the monitoring page.

The execution status includes a completion status of at least one target action executed by at least one target device corresponding to the monitoring region. For example, a lamp corresponding to a sofa area is adjusted from white to yellow.

Specifically, the computer device acquires execution status after the target device executes the automation control scheme corresponding to the action state, and displays execution status of automation control schemes of the respective monitoring regions in the monitoring page. Certainly, if there is a target device that does not execute the automation control scheme, the computer device displays a reason why the automation control scheme is not executed in the monitoring page. For example, the lamp of the sofa area is not adjusted from white to yellow, and “not executed, lamp is in an off state” is displayed in the monitoring page. This is only an example, and does not limit an execution status display scheme of the present solution. A user may conveniently view execution status of automation control schemes of target devices in the monitoring regions, and user experience is improved.

In another embodiment, a device control method is provided. The target space is a user residence, and a client capable of managing a target device is installed in a terminal. The client may be an application client, and the client includes a region editing page for custom configuring a monitoring region of the target space. In response to any region selected in the region editing page, a custom monitoring region is generated. For example, the custom monitoring region includes a washing area, a porch, a bar counter and a sofa area (rest area).

In an embodiment, target signals of respective target objects under the respective monitoring regions of the target space are acquired by a millimeter wave radar sensor, feature extraction is performed on the target signals to obtain target features corresponding to the respective target objects, state classification processing is respectively performed on the target features corresponding to the respective target objects through a trained state detection model to obtain probabilities corresponding to respective action states, and the action states of the respective target objects are obtained based on the probabilities of the respective action states. Training of the state detection model refers to the foregoing embodiments.

In an embodiment, each action state of each target object is obtained by: performing feature extraction on a target signal corresponding to each target object under each monitoring region of the target space, and performing state classification processing on an obtained target feature of each target object. A specific procedure of feature extraction refers to the foregoing embodiments.

In an embodiment, the target signal includes a radar signals; each action state of the respective target object is obtained by performing Doppler feature extraction on the radar signal corresponding to each target object, and obtaining, based on an obtained Doppler feature; and the Doppler feature includes at least one of motion intensity, frequency, motion period, Doppler bandwidth and Doppler offset. A specific procedure of Doppler feature extraction refers to the foregoing embodiments.

If the region type of the monitoring region of the target space and the action states of the respective target objects satisfy trigger conditions in automation control schemes corresponding to the monitoring regions, the computer device may instruct target devices corresponding to the monitoring regions to execute target actions in the automation control schemes. For example, when at least one target object whose action state is falling is detected in the washing area, an alarm device is controlled to send out early warning information. When the computer device detects that at least one target object whose action state is motion exists in the porch, the motion direction is toward indoors, and the target object leaves the porch, the computer device may turn off a lamp corresponding to the porch, and control an audio device to send out voice for prompting door closing. When detecting that the motion direction of at least one target object is toward a door, and the target object disappears from the porch, the computer device may turn off an indicator lamp, and control the audio device to send out voice for prompting door closing. When no target object is detected in the sofa area within a preset duration or a target object is detected and the action state of the target object is static, the computer device may turn off a lamp corresponding to the sofa area, adjust brightness of the lamp or change color of the lamp, etc. When the computer device detects that the action state of the target object is micro motion in the bar counter, the computer device controls to adjust brightness of a lamp and an audio device to play music, etc.

In a monitoring page of the client, respective monitoring regions in a target region are included, and action states of target objects in the monitoring regions are displayed in real time. After execution status are acquired after a target device executes an automation control scheme corresponding to an action state, execution status of automation control schemes of the respective monitoring regions are displayed in the monitoring page.

In the technical solution of the embodiments of the present application, target signals of target objects in the monitoring regions are acquired to obtain target features, the target features are processed through the state detection model to obtain action states, automation control schemes corresponding to the action states are determined, and then target devices corresponding to the monitoring regions are controlled through the automation control schemes, so that the target devices execute target actions in the automation control schemes. In addition, in the embodiments of the present application, a user may view action states of target objects and execution status of automation control schemes in the monitoring regions in the monitoring page of the client. The user may also custom configure monitoring regions in the region editing page, so that user experience is improved. The technical solution of the embodiments of the present application implements control of actions of target devices corresponding to the monitoring regions according to the action states of the target objects in the monitoring regions, so that flexibility and accuracy of control of the target devices are improved.

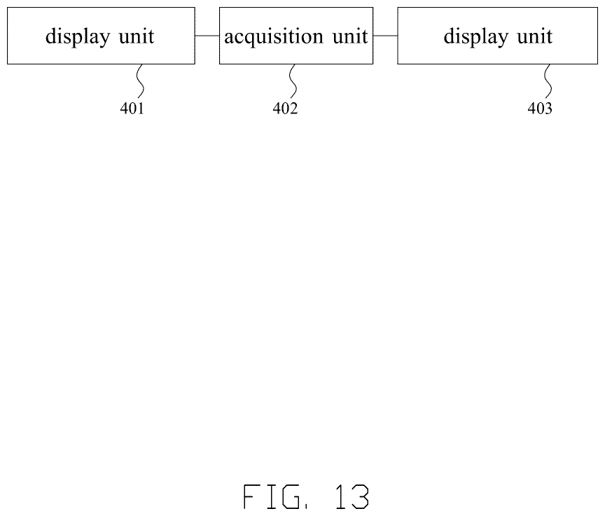

To better implement the above methods, an embodiment of the present disclosure further provides a target detection apparatus. For example, as shown in FIG. 13, the target detection apparatus may include a display unit 401, an acquisition unit 402 and a display unit 403.

The display unit 401 is configured to display a target detection page;

The acquisition unit 402 is configured to acquire position information of a target object in a target space, wherein the position information is determined by motion trajectory data of the target object in the target space;

The display unit 403 is configured to display in real time in the target detection page a position marker corresponding to the target object, wherein the page position of the position marker is determined based on the position information of the target object in the target space.

In some implementations, the acquisition unit 402 is further configured to: determine the position information by motion trajectory data of the target object in the target space, wherein the motion trajectory data is derived by using a point cloud of the target object in the target space to update historical motion trajectories associated with the point cloud.

In some implementations, the target detection page contains a plurality of position markers, each position marker corresponds to one target object, and the target detection apparatus further includes a deletion unit configured to: when position information of the target object in the target space is not acquired within a preset duration, delete the position marker corresponding to the target object from the target detection page.

In some implementations, the target detection page includes an information display page and a monitoring page, the monitoring page includes a monitoring region for responding to an automation control scheme, and the target detection apparatus further includes a trigger unit configured to: acquire an information display instruction for the monitoring region, wherein the information display instruction is triggered when any position marker first appears in the monitoring region or when all position markers have left the monitoring region; and based on the information display instruction, display in the information display page time information when any position marker is in the monitoring region, and/or display an execution status of the automation control scheme.

It may be known from the above that, in the embodiments of the present disclosure, a position marker of a target object in a target space may be viewed in real time through the target detection page in the terminal, a status of an automation control service triggered by the target object in a monitoring region in the target space is recorded and displayed, and time information of the target object in the monitoring region is displayed. Point clouds in the target space are detected, and point clouds associated with motion trajectories of the target object are configured to calculate current position information of the target object, so that accuracy of position detection of the target object is improved, and user experience is improved.

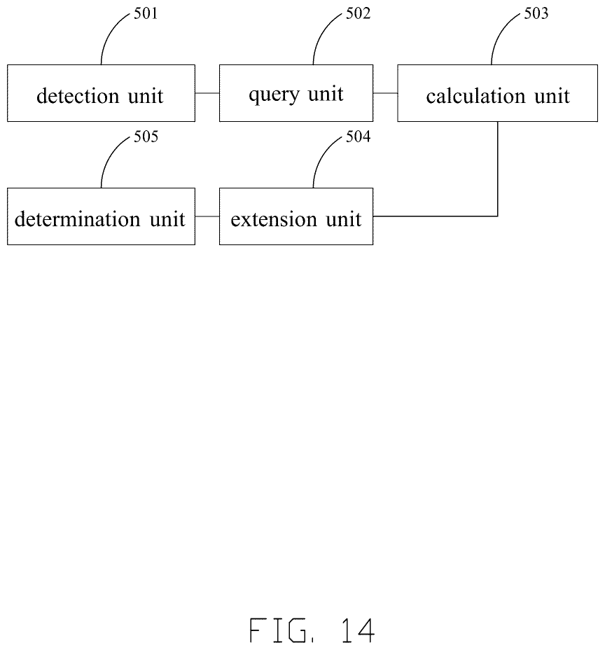

To better implement the above methods, an embodiment of the present disclosure further provides a target detection apparatus. For example, as shown in FIG. 14, the target detection apparatus may include a detection unit 501, a query unit 502, a calculation unit 503, an extension unit 504 and a determination unit 505.

The detection unit 501 is configured to acquire point cloud data frames in a target space collected in real time by a detection device, the point cloud data frames comprising at least one point cloud;

The query unit 502 is configured to, according to distance relationships, query from historical motion trajectories a target motion trajectory associable with the point cloud, wherein the target motion trajectory is jointly constructed from point clouds in one or more frames of historical point cloud data frames;

The calculation unit 503 is configured to calculate a target trajectory point of the target motion trajectory by using point clouds associable with the target motion trajectory;

The extension unit 504 is configured to extend the target motion trajectory to a corresponding target trajectory point to obtain motion trajectory data;

The determination unit 505 is configured to determine position information of the target object in the target space based on the motion trajectory data.

In some implementations, the query unit 502 is further configured to: determine the distance relationships based on distance values between the point cloud and respective historical motion trajectories; and when a historical motion trajectory whose distance value is smaller than a preset distance threshold is found based on the distance relationships, determine the historical motion trajectory having the smallest distance value as the target motion trajectory, and associate the point cloud with the target motion trajectory.

In some implementations, the target detection apparatus further includes a creation unit configured to: when no historical motion trajectory associable with the point cloud is found according to the distance relationship, determine, from point clouds in the point cloud data frame that are not associated with historical motion trajectories, a target data point cloud that has a largest number of point clouds within a preset distance range thereof; and create a target motion trajectory based on the target data point cloud and point clouds within the preset distance range thereof.

In some implementations, the point cloud data frame includes moving point clouds acquired by a moving target detection scheme and static point clouds acquired by a static target detection scheme, and the creation unit is further configured to: select, from point clouds in the point cloud data frame that are not associated with historical motion trajectories, the moving point clouds; determine a first point cloud quantity corresponding to each moving point cloud, and identify moving point clouds whose first point cloud quantity is greater than a preset moving point number threshold as candidate moving point clouds, wherein the first point cloud quantity is a number of moving point clouds within a preset range of the moving point cloud; determine a second point cloud quantity of each candidate moving point cloud, and identify candidate moving point clouds whose second point cloud quantity is greater than a preset static point number threshold as pending data point clouds, wherein the second point cloud quantity is a number of static point clouds within the preset range of the candidate moving point cloud; determine a total point cloud quantity of each pending data point cloud, and identify the pending data point cloud having the largest total point cloud quantity as the target data point cloud, wherein the total point cloud quantity is a sum of the first point cloud quantity and the second point cloud quantity.

In some implementations, the calculation unit 503 is further configured to: calculate, through a tracking filter algorithm, a first predicted trajectory point corresponding to point clouds in a current point cloud data frame associable with the target motion trajectory; determine, from the target motion trajectory, a historical target trajectory point of a previous frame, and calculate, based on the historical target trajectory point, a second predicted trajectory point corresponding to the point cloud; and calculate the first predicted trajectory point and the second predicted trajectory point according to a preset weight ratio to obtain a target trajectory point of the target motion trajectory.

In some implementations, the target detection apparatus further includes a judgment unit configured to: within a preset time, acquire a plurality of frames of point cloud data frames, and when detecting that the number of frames in which the target motion trajectory is associated within the preset time is smaller than a preset frame number threshold, delete the target motion trajectory; and/or, when detecting that, within the preset time, the frequency at which the target motion trajectory is associated with moving point clouds in the point cloud data frame is smaller than a preset frequency threshold, delete the target motion trajectory, wherein the point cloud data frame includes moving point clouds acquired by a moving target detection scheme and static point clouds acquired by a static target detection scheme.

In some implementations, the target detection apparatus further includes a sending unit configured to: send the position information to a display terminal, so that the display terminal displays in real time in the target detection page a position marker corresponding to the target object based on the position information.

It may be known from the above that, in the embodiments of the present disclosure, after the target detection page is displayed on the terminal, the position information of the target object in the target space is accurately determined according to the motion trajectory data of the target object, so as to avoid confusion of position information caused by too close distances among a plurality of target objects in the target space, and the position marker of the target object is displayed in real time in the target detection page according to the position information, so as to provide visual service for a user. In this way, the motion trajectory of the target object is updated according to point cloud data in the target space, so that the position information of each object is accurately acquired according to the motion trajectory, and the user experience is improved.

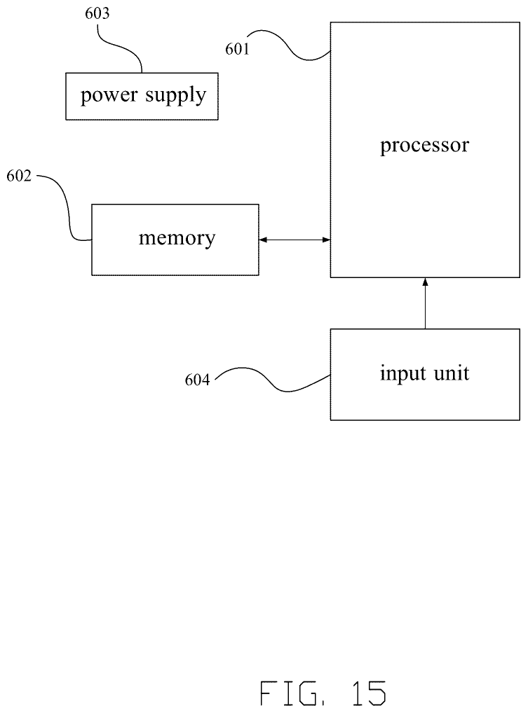

An embodiment of the present disclosure further provides a computer device. As shown in FIG. 15, FIG. 15 shows a structural schematic diagram of the computer device involved in the embodiments of the present disclosure. Specifically:

The computer device may include components such as a processor 601 having one or more processing cores, a memory 602 having one or more computer readable storage media, a power supply 603, and an input unit 604. A person skilled in the art may understand that the structure of the computer device shown in FIG. 15 does not constitute a limitation on the computer device, and the computer device may include more or fewer components than those shown in the figure, or combine some components, or have different component arrangements. Wherein:

The processor 601 is a control center of the computer device, and connects all parts of the entire computer device by using various interfaces and lines. The processor 601 performs various functions of the computer device and processes data by running or executing software programs and/or modules stored in the memory 602 and calling data stored in the memory 602. Optionally, the processor 601 may include one or more processing cores. The processor 601 may integrate an application processor and a modem processor, wherein the application processor mainly processes an operating system, a user interface, application programs, etc., and the modem processor mainly processes wireless communication. It may be understood that the above modem processor may not be integrated into the processor 601.

The memory 602 may be configured to store software programs and modules. The processor 601 performs various function applications and data processing by running the software programs and modules stored in the memory 602. The memory 602 may mainly include a program storage area and a data storage area, wherein the program storage area may store an operating system, application programs required by at least one function (such as a sound playing function and an image playing function), etc., and the data storage area may store data created according to use of the computer device, etc. In addition, the memory 602 may include a high speed random access memory, and may further include a nonvolatile memory, for example, at least one disk storage device, a flash memory device or other volatile solid state storage devices. Correspondingly, the memory 602 may further include a memory controller to provide the processor 601 with access to the memory 602.

The computer device further includes the power supply 603 configured to supply power to respective components. Preferably, the power supply 603 may be logically connected to the processor 601 through a power management system, so that functions such as charge management, discharge management and power consumption management are implemented through the power management system. The power supply 603 may further include one or more direct current or alternating current power supplies, a recharging system, a power supply fault detection circuit, a power supply converter or an inverter, a power supply state indicator, and any other component.

The computer device may further include the input unit 604. The input unit 604 may be configured to receive input digital or character information, and generate keyboard, mouse, joystick, optical or trackball signal inputs related to user settings and function control.

Although not shown, the computer device may further include a display unit, etc., which is not described herein again. Specifically, in the embodiments of the present disclosure, the processor 601 in the computer device loads executable files corresponding to processes of one or more application programs into the memory 602 according to the following instructions, and runs application programs stored in the memory 602 by the processor 601, so as to implement various functions, as follows:
displaying a target detection page; acquiring position information of a target object in a target space, wherein the position information is determined by motion trajectory data of the target object in the target space; and displaying in real time in the target detection page a position marker corresponding to the target object, wherein the page position of the position marker is determined based on the position information of the target object in the target space.
or acquiring point cloud data frames in a target space collected in real time by a detection device, the point cloud data frames comprising at least one point cloud; according to distance relationships, querying from historical motion trajectories a target motion trajectory associable with the point cloud, wherein the target motion trajectory is jointly constructed from point clouds in one or more frames of historical point cloud data frames; calculating a target trajectory point of the target motion trajectory by using point clouds associable with the target motion trajectory; extending the target motion trajectory to a corresponding target trajectory point to obtain motion trajectory data; and determining position information of the target object in the target space based on the motion trajectory data.

Specific implementations of the above operations may refer to the foregoing embodiments, which are not described herein again.

It may be known from the above that, in the present solution, after the target detection page is displayed on the terminal, the position information of the target object in the target space is accurately determined according to the motion trajectory data of the target object, so as to avoid confusion of position information caused by too close distances among a plurality of target objects in the target space, and the position marker of the target object is displayed in real time in the target detection page according to the position information, so as to provide visual service for a user. In this way, the motion trajectory of the target object is updated according to point cloud data in the target space, so that the position information of each object is accurately acquired according to the motion trajectory, and the user experience is improved.

A person of ordinary skill in the art may understand that all or part of steps in the various methods of the above embodiments may be completed by instructing relevant hardware through an instruction. The instruction may be stored in a computer readable storage medium and loaded and executed by a processor.

In an embodiment, the present disclosure provides a computer program product or computer program. The computer program product or computer program includes computer instructions, and the computer instructions are stored in a computer readable storage medium. A processor of a computer device reads the computer instructions from the computer readable storage medium, and the processor executes the computer instructions, so that the computer device executes steps in the above method embodiments.

In an embodiment, the present disclosure provides a computer readable storage medium. Computer readable instructions are stored on the computer readable storage medium. When the computer readable instructions are executed by a processor, steps in the above method embodiments are implemented. For specific limitations on the steps, reference may be made to limitations on the target detection method in the method embodiments, which are not described herein again.

A person of ordinary skill in the art may understand that all or part of the procedures in the methods of the above embodiments may be completed by a computer program instructing relevant hardware. The computer program may be stored in a nonvolatile computer readable storage medium. When the computer program is executed, the procedures of the embodiments of the above methods may be included. Wherein, any reference to a memory, storage, database or other medium used in the embodiments provided by the present disclosure may include a nonvolatile memory and/or a volatile memory. The nonvolatile memory may include a read only memory (ROM), a programmable ROM (PROM), an electrically programmable ROM (EPROM), an electrically erasable programmable ROM (EEPROM) or a flash memory. The volatile memory may include a random access memory (RAM) or an external high speed cache. As illustrative rather than limiting, RAM may be obtained in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM), and a memory bus dynamic RAM (RDRAM), etc.

The technical features of the above embodiments may be combined arbitrarily. For concise description, not all possible combinations of the technical features in the above embodiments are described. However, as long as there is no contradiction in the combinations of the technical features, the combinations should be considered as the scope described in the present specification.

The above embodiments only express several implementation manners of the present disclosure, and the description is specific and detailed, but should not be construed as a limitation on the patent scope of the present disclosure. It should be noted that, for a person of ordinary skill in the art, several variations and improvements may be made without departing from the concept of the present disclosure, and these all fall within the protection scope of the present disclosure. Therefore, the protection scope of the patent of the present disclosure shall be subject to the appended claims.

What is claimed is:

1. A target detection method, performed by a computer device, the method comprises:
displaying a target detection page;
acquiring position information of a target object in a target space, wherein the position information is determined by motion trajectory data of the target object in the target space;
displaying in real time a position marker corresponding to the target object in the target detection page, wherein a page position of the position marker is determined based on the position information of the target object in the target space.

2. The method of claim 1, wherein the position information is determined by the motion trajectory data of the target object in the target space, comprises:
the position information is determined by the motion trajectory data of the target object in the target space, wherein the motion trajectory data is derived by using a point cloud of the target object in the target space to update historical motion trajectories associated with the point cloud.

3. The method of claim 1, wherein the target detection page comprises a plurality of position markers, and each position marker corresponds to one of target objects, after displaying in real time the position marker corresponding to the target object in the target detection page, the method further comprises:
when the position information of the target object in the target space is not acquired within a preset duration, deleting the position marker corresponding to the target object from the target detection page.

4. The method of claim 1, wherein the target detection page comprises an information display page and a monitoring page, and the monitoring page comprises a pre-set monitoring region for responding to an automation control scheme, the method further comprises:
acquiring an information display instruction for the monitoring region, wherein the information display instruction is triggered when any position marker first appears in the monitoring region, or when all position markers have left the monitoring region;
based on the information display instruction, displaying time information when any position marker is in the monitoring region, and/or displaying an execution status of the automation control scheme in the information display page.

5. The method of claim 1, wherein the target detection page comprises a monitoring page, and the monitoring page comprises at least one monitoring region corresponding to the target space, the method further comprises:
in a corresponding monitoring region of the monitoring page, displaying in real time an action state of each target object; each action state of each target object obtained by recognizing a target feature corresponding to each target object; each action state of each target object configured to instruct a corresponding target device to execute an automation control scheme corresponding to an action state.

6. The method of claim 5, wherein the method further comprises at least one of:
displaying a region editing page, wherein the region editing page is configured to custom configure the monitoring region of the target space, and in response to any region selected in the region editing page, generating a custom monitoring region;
acquiring an execution status after the target device executes the automation control scheme corresponding to the action state, and displaying in the monitoring page an execution status of the automation control scheme for each monitoring region.

7. The method of claim 5, wherein each action state of each target object is obtained by: performing feature extraction on a target signal corresponding to each target object under each monitoring region of the target space, and performing state classification processing on an obtained target feature of each target object;
wherein the target signal comprises a radar signal; each action state of each target object is obtained by performing Doppler feature extraction on the radar signal corresponding to each target object, and obtaining based on an obtained Doppler feature; wherein the Doppler feature comprises at least one of motion intensity, frequency, motion period, Doppler bandwidth and Doppler offset.

8. A device control method, performed by a computer device, the method comprises:
acquiring a point cloud data frame in a target space collected in real time by a detection device, wherein the point cloud data frame comprises at least one point cloud;
according to a distance relationship, querying from historical motion trajectories a target motion trajectory associable with the point cloud, wherein the target motion trajectory is jointly constructed from the point cloud in one or more frames of historical point cloud data;
based on the point cloud associable with the target motion trajectory, calculating a target trajectory point of the target motion trajectory;
extending the target motion trajectory to the corresponding target trajectory point, to obtain motion trajectory data;
based on the motion trajectory data, determining position information of the target object in the target space.

9. The method of claim 8, wherein according to the distance relationship, querying from historical motion trajectories the target motion trajectory associable with the point cloud, comprises:
determining the distance relationship based on distance values between the point cloud and respective historical motion trajectories;
when, based on the distance relationship, a historical motion trajectory whose distance value is smaller than a preset distance threshold is found, determining the historical motion trajectory having the smallest distance value as the target motion trajectory, and associating the point cloud with the target motion trajectory.

10. The method of claim 8, wherein the method further comprises:
when, based on the distance relationship, no historical motion trajectory associable with the point cloud is found, determining, from a point cloud in the point cloud data frame that is not associated with historical motion trajectories, a target data point cloud that has a largest number of point clouds within a preset distance range thereof;
creating the target motion trajectory based on the target data point cloud and the point clouds within the preset distance range thereof.

11. The method of claim 10, wherein the point cloud data frame comprises moving point clouds acquired by a moving target detection scheme and static point clouds acquired by a static target detection scheme, and wherein determining, from the point cloud in the point cloud data frame that is not associated with the historical motion trajectories, the target data point cloud, comprises:
selecting, from point clouds in the point cloud data frame that are not associated with historical motion trajectories, the moving point clouds;
determining a first point cloud quantity for each moving point cloud, and identifying moving point clouds whose first point cloud quantity is greater than a preset moving point number threshold as candidate moving point clouds, wherein the first point cloud quantity is a number of moving point clouds within a preset range of the moving point clouds;
determining a second point cloud quantity for each candidate moving point cloud, and identifying candidate moving point clouds whose second point cloud quantity is greater than a preset static point number threshold as pending data point clouds, wherein the second point cloud quantity is a number of static point clouds within the preset range of the candidate moving point clouds;
determining a total point cloud quantity for each pending data point cloud, and identifying the pending data point cloud having the largest total point cloud quantity as the target data point cloud, wherein the total point cloud quantity is a sum of the first point cloud quantity and the second point cloud quantity.

12. The method of claim 8, wherein based on the point cloud associable with the target motion trajectory, calculating the target trajectory point of the target motion trajectory, comprises:
calculating, through a tracking filter algorithm, a first predicted trajectory point corresponding to the point cloud in a current point cloud data frame associable with the target motion trajectory;
determining, from the target motion trajectory, a historical target trajectory point of a previous frame, and calculating, based on the historical target trajectory point, a second predicted trajectory point corresponding to the point cloud;
calculating, according to a preset weight ratio, the first predicted trajectory point and the second predicted trajectory point to obtain the target trajectory point of the target motion trajectory.

13. The method of claim 8, wherein the method further comprises:
within a preset time period, acquiring a plurality of the point cloud data frames, and when detecting a number of frames in which the target motion trajectory is associated is smaller than a preset frame number threshold, deleting the target motion trajectory;
and/or, when detecting, within the preset time period, a frequency at which the target motion trajectory is associated with moving point clouds in the point cloud data frame, is smaller than a preset frequency threshold, deleting the target motion trajectory, wherein the point cloud data frame comprises the moving point clouds acquired by a moving target detection scheme and static point clouds acquired by a static target detection scheme.

14. The method of claim 8, wherein after based on the motion trajectory data, determining position information of the target object in the target space, the method further comprises:
sending the position information to a display terminal, so that the display terminal, based on the position information, displays in real time in a target detection page a position marker corresponding to the target object.

15. The method of claim 8, wherein the method further comprises:
Acquiring a target feature corresponding to each target object under each monitoring region of the target space;
performing a state detection on the target feature of each target object, to obtain an action state of each target object;
according to the action state of each target object, determining an automation control scheme corresponding to the action state of each target object, so as to instruct a corresponding target device to execute the automation control scheme.

16. The method of claim 15, wherein acquiring the target feature corresponding to each target object under each monitoring region of the target space, comprises:
acquiring a target signal corresponding to each target object under each monitoring region of the target space;
performing feature extraction on the target signal to obtain the target feature corresponding to each target object;
performing the state detection on the target feature of each target object, to obtain the action state of each target object, comprising:
respectively performing state classification processing on the target feature of each target object, to obtain the action state of each target object.

17. The method of claim 15, wherein performing the state detection on the target feature of each target object, to obtain the action state of each target object, comprises:
for the target feature corresponding to each target object, respectively performing state classification processing on the target feature corresponding to each target object through a trained state detection model to obtain a probability corresponding to each action state;
based on the probability of each action state, determining the action state of each target object.

18. The method of claim 17, wherein the state detection model is obtained through model training steps, the model training steps comprise:
acquiring sample target features of sample target objects under different action states, and generating, based on the sample target features, sample sets respectively corresponding to the action states; each of the sample sets comprises positive samples for a current action state and negative samples for action states other than the current action state, and corresponding sample labels; wherein the sample labels comprise sample labels for the positive samples and sample labels for the negative samples;
respectively performing state detection on the sample target features in the sample sets corresponding to the action states through each branch model in an initial model to obtain sample state results;
based on differences between the sample state results and the corresponding sample labels, adjusting model parameters of each branch model in the initial model and continuing training until training conditions are met, and stopping training to obtain the trained state detection model.

19. The method of claim 15, wherein according to the action state of each target object, determining the automation control scheme corresponding to the action state of each target object, comprises:
when the action state of each target object under a monitoring region of the target space, satisfies a trigger condition in an automation control scheme of the monitoring region, instructing a corresponding target device, to execute a target action in the automation control scheme; or
when a region type of the monitoring region and the action state of each target object, satisfy a trigger condition in an automation control scheme of the monitoring region, instructing a corresponding target device, to execute a target action in the automation control scheme; or
determining the automation control scheme of the action state of each target object, according to an action category and a movement direction in the action state of each target object.

20. A computer device, comprising a memory and a processor, wherein the memory stores instructions which, when executed by the processor, cause the processor to carry out the method according to claim 1.
